(19) United States
(12) Patent Application Publication
(10) Pub. No.: US 2021/0070300 A1
(43) Pub. Date: Mar. 11, 2021

(54) SYSTEMS AND METHODS FOR LANE BROADCAST

(71) Applicant: BEIJING DIDI INFINITY TECHNOLOGY AND DEVELOPMENT CO., LTD., Beijing (CN)

(72) Inventor: Guoyu SUN, Beijing (CN)

(73) Assignee: BEIJING DIDI INFINITY TECHNOLOGY AND DEVELOPMENT CO., LTD., Beijing (CN)

(21) Appl. No.: 17/081,985

(22) Filed: Oct. 27, 2020

Related U.S. Application Data
(63) Continuation of application No. PCT/CN2019/084672, filed on Apr. 26, 2019.

(30) Foreign Application Priority Data
Apr. 27, 2018 (CN) 201810396558.4

(51) Int. Cl. B60W 30/18; B60W 30/12

(52) U.S. Cl. CPC B60W 30/18154; B60W 30/12; B60W 2552/10; B60W 2556/65; B60W 30/18159

(57) ABSTRACT

The present disclosure relates to systems and methods for a lane broadcast. The systems and methods may determine a motion of a vehicle to be performed when the vehicle is going to arrive at an intersection based on a planned driving route and a current location of the vehicle. The systems and methods may determine one or more lane groups, and determine a lane status based on the motion of the vehicle and the one or more lane groups. The systems and methods may determine a lane broadcast manner based on the lane status and the motion of the vehicle. The lane status may be a status of road composed of different lane groups of the one or more lane groups.

### CROSS-REFERENCE TO RELATED APPLICATIONS

This application is a continuation of International Application No. PCT/CN2019/084672 filed on Apr. 26, 2019, which claims priority of Chinese Patent Application No. 201810396558.4, filed on Apr. 27, 2018, the entire contents of each of which are hereby incorporated by reference in their entirety.

### TECHNICAL FIELD

The present disclosure generally relates to navigation services, and in particular, to systems and methods for a lane broadcast.

### BACKGROUND

Online to offline (O2O) services (e.g., car-hailing services, etc.) are becoming increasingly popular in daily life, and may facilitate on-board navigation. Navigation services generally help a driver find a direction from a departure location to the destination, and can be implemented through a navigation system. When the driver approaches an intersection, the navigation system may direct the driver to drive (e.g., going straight, turning left, turning right, turning around). In general, a road may include several lanes having different lane marks (e.g., a going straight mark, a left turn mark, a right turn mark, a U-turn mark). When approaching the intersection, the driver takes an action on the corresponding lane according to the direction of the navigation system. For example, directed to make a left turn, the driver may make the left turn on a lane with the left turn mark. However, if a road has a plurality of lanes (e.g., 6 lanes, and 8 lanes), and/or the driver is unfamiliar with the road, the driver may sometimes take the action on a wrong lane violating traffic rules. Thus, it is desired to provide systems and methods for a lane broadcast to ensure the driver takes a desired action on the right lane(s).

### SUMMARY

In one aspect of the present disclosure, a lane-based broadcast method is provided. The method may be implemented on a computing device having at least one processor, at least one storage medium, and a communication platform connected to a network. The method may include determining a motion of a vehicle to be performed when the vehicle is going to arrive at an intersection based on a planned driving route and a current location of the vehicle, and determining one or more lane groups. The method may also include determining a lane status based on the motion of the vehicle and the one or more lane groups. The method may also include determining a lane broadcast manner based on the motion of the vehicle and the lane status. The lane status may be a status of road composed of different lane groups of the one or more lane groups.

In some embodiments, the motion of the vehicle may include at least one of going straight, making a left turn, making a right turn, or making a U-turn.

In some embodiments, the determining one or more lane groups may include classifying a plurality of lanes into the one or more lane groups according to lane marks on the plurality of lanes.

In some embodiments, the determining a lane status may include determining a passable lane group and an impassable lane group based on the motion of the vehicle and the one or more lane groups, and determining the lane status based on the passable lane group and the impassable lane group.

In some embodiments, each lane in each lane group of the one or more lane groups may have a same lane mark.

In some embodiments, the lane marks may include at least one of a going straight mark, a left turn mark, a right turn mark, a U-turn mark, or a special lane mark.

In some embodiments, the one or more lane groups may include at least one of a going straight lane group, a left turn lane group, a right turn lane group, a U-turn lane group, or a special lane group.

In some embodiments, the lane status may include a void lane status and an ordinary lane status.

In some embodiments, the void lane status may refer to a state that a single impassable lane of the impassable lane group is adjacent to only a passable lane of the passable lane group, or multiple adjacent impassable lanes of the impassable lane group are flanked by only a passable lane of the passable lane group.

In some embodiments, the ordinary lane status may refer to a state that a single impassable lane of the impassable lane group is adjacent to at least one impassable lane of the impassable lane group.

In some embodiments, the lane broadcast manner may include a positive lane broadcast manner, a negative lane broadcast manner, or a combination of a positive lane broadcast manner and a negative lane broadcast manner.

In some embodiments, if the lane status is the void lane status, the lane broadcast manner may be the negative lane broadcast manner.

In some embodiments, the void lane status may be regarded as two or more of the ordinary lane status. The lane broadcast manner of the void lane status may be determined based on a lane broadcast manner of each of the two or more ordinary lane statuses.

In some embodiments, if the lane status is the ordinary lane status, the method may include determining the lane broadcast manner based on a number of lanes in the passable lane group, a number of lanes on the left of the passable lane group, a number of lanes on the right of the passable lane group.

In some embodiments, the determining the lane broadcast manner may include determining whether a total number of lanes is equal to the number of lanes in the passable lane group; in response to a determination that the total number of lanes is equal to the number of lanes in the passable group, determining that it is not required to perform the lane broadcast; and in response to a determination that the total number of lanes is not equal to the number of lanes in the passable group, determining the lane broadcast manner based on the number of lanes in the passable lane group, the number of lanes on the left of the passable lane group, the number of lanes on the right of the passable lane group, and the motion of the vehicle.

In some embodiments, the at least one processor may be directed to perform a lane broadcast according to the determined lane broadcast manner when a distance between the current location of the vehicle and the intersection is less than a first threshold.

In some embodiments, the at least one processor may further include determining a continuous lane broadcast when continuous intersections exist.

In some embodiments, the determining a continuous lane broadcast manner may include determining a maximum number of lane change, an average lane change distance, a possible lane change distance, and a minimum reserved going straight distance; determining whether a product of the maximum number of lane change multiplied by the average lane change distance is greater than the possible lane change distance; and in response to a determination that the product of the maximum number of lane change multiplied by the average lane change distance is greater than the possible lane change distance, determining that a distance for lane change is insufficient, and directing a driver to drive to a lane with a least number of lane change in advance.

In yet another aspect of the present disclosure, a lane broadcast system is provided. The system may include at least one storage device, and at least one processor in communication with the at least one storage device. The at least one storage device may include a set of instructions. When executing the set of instructions, the at least one processor may be directed to determine a motion of a vehicle to be performed at an intersection based on a driving route and a current location of the vehicle. The at least one processor may also be directed to determine a motion of a vehicle to be performed when the vehicle is going to arrive at an intersection based on a planned driving route and a current location of the vehicle. The at least one processor may also be directed to determine one or more lane groups, and determine a lane status based on the motion of the vehicle and the one or more lane groups. The at least one processor may be further directed to determine a lane broadcast manner based on the motion of the vehicle and the lane status. The lane status may be a status of road composed of different lane groups of the one or more lane groups.

In yet another aspect of the present disclosure, a non-transitory computer-readable storage medium is provided. The non-transitory computer-readable storage medium may include at least one set of instructions. When executed by at least one processor of a computing device, the at least one set of instructions may direct the at least one processor to perform acts of determining a motion of a vehicle to be performed when the vehicle is going to arrive at an intersection based on a driving route and a current location of the vehicle; determining one or more lane groups; determining a lane status based on the motion of the vehicle and the one or more lane groups; and determining a lane broadcast manner based on the lane status and the motion of the vehicle. The lane status may be a status of road composed of different lane groups of the one or more lane groups.

In another aspect of the present disclosure, a lane-based broadcast system is provided. The system may include a vehicle motion determination module, a lane group determination module, a lane status determination module, and a broadcast manner determination module. The vehicle motion determination module may be configured to determine a motion of a vehicle. The lane group determination module may be configured to determine one or more lane groups. The lane status determination module may be configured to determine a lane status. The broadcast manner determination module may be configured to determine a lane broadcast manner based on the motion of the vehicle and the lane status.

In yet another aspect of the present disclosure, a lane-based broadcast apparatus is provided. The apparatus may include a processor configured to run programs. When running the programs, the processor may perform the lane-based broadcast method described above.

In yet another aspect of the present disclosure, a computer-readable storage medium is provided. The computer-readable storage medium may store at least one set of computer instructions. When a computer reads the at least one set of computer instructions, the computer may perform the lane-based broadcast method described above.

In yet another aspect of the present disclosure, a vehicle is provided. The vehicle may perform a lane broadcast. The lane broadcast may be determined according to the lane-based broadcast method described above.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary O2O service system according to some embodiments of the present disclosure;

FIG. 2 is a schematic diagram illustrating exemplary hardware and software components of a computing device according to some embodiments of the present disclosure;

FIG. 3 is a schematic diagram illustrating exemplary hardware and/or software components of a mobile device on which a terminal may be implemented according to some embodiments of the present disclosure;

FIG. 4 is a schematic diagram illustrating an exemplary processing device according to some embodiments of the present disclosure;

FIG. 5 is a schematic diagram illustrating an exemplary lane status determination module according to some embodiments of the present disclosure;

FIG. 6 is a schematic diagram illustrating an exemplary broadcast manner determination module according to some embodiments of the present disclosure;

FIG. 7 is a flowchart illustrating an exemplary process for determining a lane broadcast manner according to some embodiments of the present disclosure;

FIG. 8 is a flowchart illustrating an exemplary process for determining a lane status according to some embodiments of the present disclosure;

FIGS. 9 and 10 are flowcharts illustrating an exemplary process for determining a lane broadcast manner according to some embodiments of the present disclosure;

FIG. 11 is a flowchart illustrating an exemplary process for determining a continuous lane broadcast manner according to some embodiments of the present disclosure;

FIG. 12 is a schematic diagram illustrating exemplary continuous intersections according to some embodiments of the present disclosure; and

FIGS. 13 through 14B are flowcharts illustrating an exemplary process for determining a lane broadcast manner according to some embodiments of the present disclosure.

### DETAILED DESCRIPTION

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been described at a relatively high-level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that the term “system,” “engine,” “unit,” “module,” and/or “block” used herein are one method to distinguish different components, elements, parts, section or assembly of different level in ascending order. However, the terms may be displaced by another expression if they achieve the same purpose.

Generally, the word “module,” “unit,” or “block,” as used herein, refers to logic embodied in hardware or firmware, or to a collection of software instructions. A module, a unit, or a block described herein may be implemented as software and/or hardware and may be stored in any type of non-transitory computer-readable medium or other storage device. In some embodiments, a software module/unit/block may be compiled and linked into an executable program. It will be appreciated that software modules can be callable from other modules/units/blocks or from themselves, and/or may be invoked in response to detected events or interrupts. Software modules/units/blocks configured for execution on computing devices may be provided on a computer-readable medium, such as a compact disc, a digital video disc, a flash drive, a magnetic disc, or any other tangible medium, or as a digital download (and can be originally stored in a compressed or installable format that needs installation, decompression, or decryption prior to execution). Such software code may be stored, partially or fully, on a storage device of the executing computing device, for execution by the computing device. Software instructions may be embedded in a firmware, such as an erasable programmable read-only memory (EPROM). It will be further appreciated that hardware modules/units/blocks may be included in connected logic components, such as gates and flip-flops, and/or can be included of programmable units, such as programmable gate arrays or processors. The modules/units/blocks or computing device functionality described herein may be implemented as software modules/units/blocks, but may be represented in hardware or firmware. In general, the modules/units/blocks described herein refer to logical modules/units/blocks that may be combined with other modules/units/blocks or divided into sub-modules/sub-units/sub-blocks despite their physical organization or storage. The description may be applicable to a system, an engine, or a portion thereof.

It will be understood that when a unit, engine, module or block is referred to as being “on,” “connected to,” or “coupled to,” another unit, engine, module, or block, it may be directly on, connected or coupled to, or communicate with the other unit, engine, module, or block, or an intervening unit, engine, module, or block may be present, unless the context clearly indicates otherwise. As used herein, the term “and/or” includes any and all combinations of one or more of the associated listed items.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments in the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

Embodiments of the present disclosure may be applied to different transportation systems including but not limited to land transportation, sea transportation, air transportation, space transportation, or the like, or any combination thereof. A vehicle of the transportation systems may include a rickshaw, travel tool, taxi, chauffeured car, hitch, bus, rail transportation (e.g., a train, a bullet train, high-speed rail, and subway), ship, airplane, spaceship, hot-air balloon, driverless vehicle, or the like, or any combination thereof. The transportation system may also include any transportation system that applies management and/or distribution, for example, a system for sending and/or receiving an express.

The application scenarios of different embodiments of the present disclosure may include but not limited to one or more webpages, browser plugins and/or extensions, client terminals, custom systems, intracompany analysis systems, artificial intelligence robots, or the like, or any combination thereof. It should be understood that application scenarios of the system and method disclosed herein are only some examples or embodiments. Those having ordinary skills in the art, without further creative efforts, may apply these drawings to other application scenarios. For example, other similar server.

The term “passenger,” “requester,” “requestor,” “service requester,” “service requestor” and “customer” in the present disclosure are used interchangeably to refer to an individual, an entity or a tool that may request or order a service. Also, the term “driver,” “provider,” “service provider,” and “supplier” in the present disclosure are used interchangeably to refer to an individual, an entity or a tool that may provide a service or facilitate the providing of the service. The term “user” in the present disclosure may refer to an individual, an entity or a tool that may request a service, order a service, provide a service, or facilitate the providing of the service. For example, the user may be a requester, a passenger, a driver, an operator, or the like, or any combination thereof. In the present disclosure, “requester” and “requester terminal” may be used interchangeably, and “provider” and “provider terminal” may be used interchangeably.

The term “request,” “service,” “service request,” and “order” in the present disclosure are used interchangeably to refer to a request that may be initiated by a passenger, a requester, a service requester, a customer, a driver, a provider, a service provider, a supplier, or the like, or any combination thereof. The service request may be accepted by any one of a passenger, a requester, a service requester, a customer, a driver, a provider, a service provider, or a supplier. The service request may be chargeable or free.

An aspect of the present disclosure relates to systems and methods for lane broadcast. The systems and methods may determine a motion of a vehicle to be performed at an intersection (e.g., an intersection at which the vehicle is going to arrive) based on a driving route and a current location of the vehicle. The motion of the vehicle may include going straight, making a left turn, making a right turn, making a U-turn, or the like. The systems and methods may further determine one or more lane groups, and determine a lane status based on the motion of the vehicle and the one or more lane groups. The lane status may include a void lane status and an ordinary lane status. The systems and methods may determine a lane broadcast manner based on the lane status and the motion of the vehicle. When a distance between the current location of the vehicle and the intersection is less than a first threshold, the systems and methods may perform a lane broadcast according to the determined lane broadcast manner. According to the lane broadcast, a driver can drive to one or more passable lanes timely before passing the intersection. In some embodiments, the systems and methods may determine a continuous lane broadcast manner when continuous intersections exist, which may direct the driver to drive to a lane corresponding to the motion of the vehicle at the next intersection after passing the intersection.

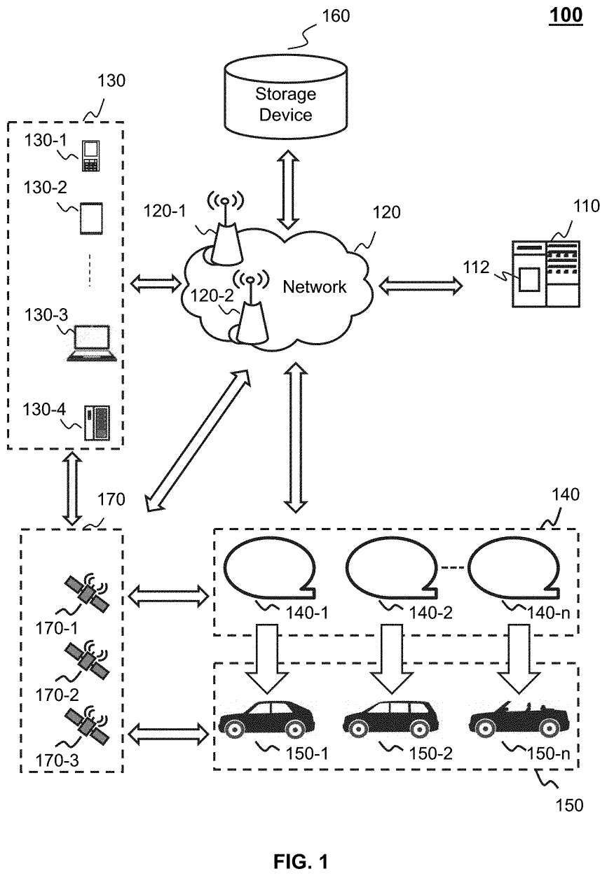

FIG. 1 is a block diagram illustrating an exemplary O2O service system 100 according to some embodiments of the present disclosure. For example, the O2O service system 100 may be an online transportation service platform for transportation services. The O2O service system 100 may include a server 110, a network 120, a requester terminal 130, a provider terminal 140, a vehicle 150, a storage device 160, and a navigation device 170.

The O2O service system 100 may provide a plurality of services. Exemplary service may include a taxi-hailing service, a chauffeur service, an express car service, a carpool service, a bus service, a driver hire service, and a shuttle service. In some embodiments, the O2O service may be any online service, such as booking a meal, shopping, or the like, or any combination thereof. In some embodiments, the O2O service system 100 may be configured to determine a lane broadcast manner for a vehicle.

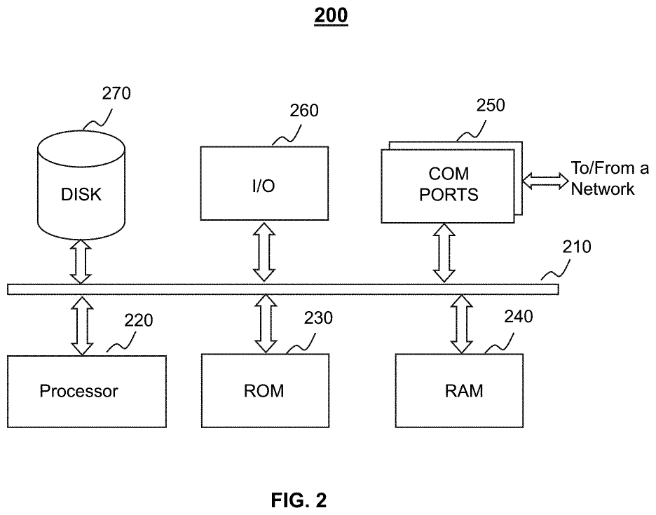

In some embodiments, the server 110 may be a single server or a server group. The server group may be centralized, or distributed (e.g., the server 110 may be a distributed system). In some embodiments, the server 110 may be local or remote. For example, the server 110 may access information and/or data stored in the requester terminal 130, the provider terminal 140, and/or the storage device 160 via the network 120. As another example, the server 110 may be directly connected to the requester terminal 130, the provider terminal 140, and/or the storage device 160 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing device 112. The processing device 112 may process information and/or data relating to lane broadcast to perform one or more functions described in the present disclosure. In some embodiments, the processing device 112 may include one or more processing engines (e.g., single-core processing engine(s) or multi-core processor(s)). Merely by way of example, the processing device 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof.

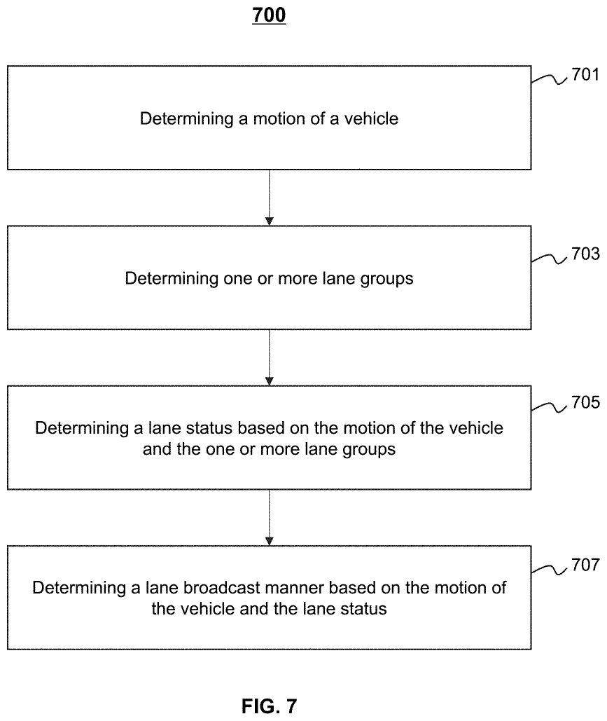

In some embodiments, the processing device 112 may determine a lane broadcast manner based on a motion of a vehicle. In some embodiments, the processing device 112 may determine a motion of a vehicle to be performed at an intersection (e.g., an intersection at which the vehicle is going to arrive) based on a driving route and a current location of the vehicle. In some embodiments, the driving route may be determined based on a departure location and a destination. The current location of the vehicle may be determined according to a GPS device installed on the vehicle (e.g., the requester terminal 130, the provider terminal 140, the navigation device 170). In some embodiments, the motion of the vehicle may include going straight, making a left turn, making a right turn, making a U-turn, or the like. The processing device 112 may determine a lane status at the intersection based on the motion of the vehicle. Specifically, the processing device 112 may determine one or more lane groups at the intersection. The processing device 112 may classify a plurality of lanes at the intersection into the one or more lane groups according to lane marks on the plurality of lanes. The lane mark(s) may include a going straight mark, a left turn mark, a right turn mark, a U-turn mark, a special lane mark, or the like. Accordingly, the lane group(s) may include a going straight lane group, a left turn lane group, a right turn lane group, a U-turn lane group, a special lane group. Each lane in a lane group may have the same lane mark. For example, for a going straight lane group, one or more lanes in the going straight lane group may have the lane mark “going straight mark”. In some embodiments, the processing device 112 may determine a passable lane group and an impassable lane group based on the one or more lane groups and the motion of the vehicle. In some embodiments, a passable lane group may include one or more lanes that the vehicle can pass through, while an impassable lane group may include one or more lanes that the vehicle cannot pass through. The processing device 112 may further determine the lane status based on the passable lane group and the impassable lane group. In some embodiments, the lane status may include a void lane status and an ordinary lane status. The void lane status may refer to a state that a single impassable lane of the impassable lane group is adjacent to only a passable lane of the passable lane group, or multiple adjacent impassable lanes of the impassable lane group are flanked by only a passable lane of the passable lane group. The ordinary lane status may refer to a state that a single impassable lane of the impassable lane group is adjacent to at least one impassable lane of the impassable lane group. The processing device 112 may determine a lane broadcast manner based on the lane status and the motion of the vehicle. The lane broadcast manner may include a positive lane broadcast manner, a negative lane broadcast manner, a combination of a positive lane broadcast manner and a negative lane broadcast manner. In some embodiments, if the lane status is a void lane status, the lane broadcast manner may be a negative lane broadcast manner. In some embodiments, a void lane status may be regarded as two or more ordinary lane statuses. The lane broadcast manner of the void lane status may be determined based on a lane broadcast manner of each of the two or more ordinary lane statuses. For an ordinary lane status, the processing device 112 may determine a lane broadcast manner based on a number of lanes in the passable lane group (i.e., a number of passable lanes), a number of lanes on the left of the passable lane group, and a number of lanes on the right of the passable lane group. In some embodiments, when a distance between the current location of the vehicle and the intersection is equal to or less than a first threshold, the processing device 112 may perform a lane broadcast according to the determined lane broadcast manner. More descriptions of the determination of the lane broadcast manner may be found elsewhere in the present disclosure (e.g., FIGS. 7-10, 13-14B and the descriptions thereof).

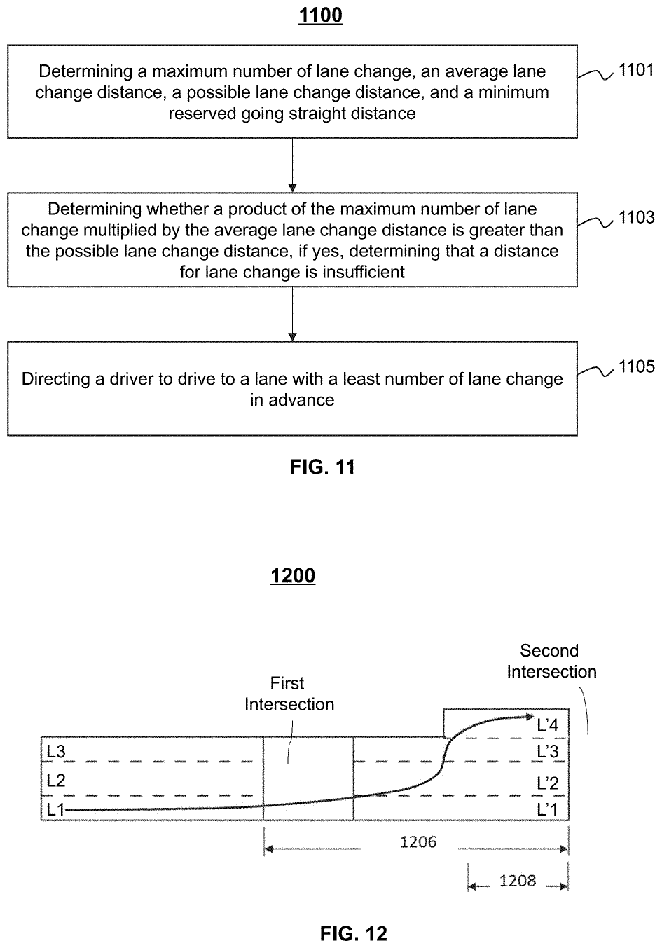

In some embodiments, when continuous intersections exist, (e.g., a distance between a first intersection and a second intersection is less than a second threshold), the processing device 112 may perform a continuous lane broadcast so that the driver can drive to a lane corresponding to the motion of the vehicle at the second intersection after passing the first intersection. Specifically, the processing device 112 may determine whether a distance between the first intersection and the second intersection is less than a second threshold. In response to a determination that the distance between the first intersection and the second intersection is less than the second threshold, the processing device 112 may determine that continuous intersections exist. The processing device 112 may determine a maximum number of lane change, an average lane change distance and a possible lane change distance between the first intersection and the second intersection. The processing device 112 may further determine whether a distance for lane change from the first intersection to the second intersection is sufficient based on the maximum number of lane change, the average lane change distance and the possible lane change distance. In response to a determination that the distance for lane change from the first intersection to the second intersection is insufficient, the processing device 112 may determine the continuous lane broadcast manner. In some embodiments, the maximum number of lane change may be determined according to one or more passable lanes in a passable lane group at the second intersection and a lane on which the vehicle runs. More descriptions of the determination of the continuous lane broadcast manner may be found elsewhere in the present disclosure (e.g., FIGS. 11 and 12 and the descriptions thereof).

The network 120 may facilitate exchange of information and/or data. In some embodiments, one or more components of the O2O service system 100 (e.g., the server 110, the requester terminal 130, the provider terminal 140, the vehicle 150, the storage device 160, and the navigation device 170) may transmit information and/or data to other component(s) of the O2O service system 100 via the network 120. For example, the server 110 may receive a service request from the requester terminal 130 via the network 120. In some embodiments, the network 120 may be any type of wired or wireless network, or combination thereof. Merely by way of example, the network 120 may include a cable network, a wireline network, an optical fiber network, a telecommunications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, through which one or more components of the O2O service system 100 may be connected to the network 120 to exchange data and/or information.

In some embodiments, a passenger may be an owner of the requester terminal 130. In some embodiments, the owner of the requester terminal 130 may be someone other than the passenger. For example, an owner A of the requester terminal 130 may use the requester terminal 130 to transmit a service request for a passenger B or receive a service confirmation and/or information or instructions from the server 110. In some embodiments, a service provider may be a user of the provider terminal 140. In some embodiments, the user of the provider terminal 140 may be someone other than the service provider. For example, a user C of the provider terminal 140 may use the provider terminal 140 to receive a service request for a service provider D, and/or information or instructions from the server 110. In some embodiments, “passenger” and “passenger terminal” may be used interchangeably, and “service provider” and “provider terminal” may be used interchangeably. In some embodiments, the provider terminal may be associated with one or more service providers (e.g., a night-shift service provider, or a day-shift service provider).

In some embodiments, the requester terminal 130 may include a mobile device 130-1, a tablet computer 130-2, a laptop computer 130-3, a built-in device in a vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, smart glasses, a smart helmet, a smart watch, smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination thereof. In some embodiments, the virtual reality device and/or the augmented reality device may include a virtual reality helmet, virtual reality glasses, a virtual reality patch, an augmented reality helmet, augmented reality glasses, an augmented reality patch, or the like, or any combination thereof. For example, the virtual reality device and/or the augmented reality device may include Google™ Glasses, an Oculus Rift, a HoloLens, a Gear VR, etc. In some embodiments, the built-in device in the vehicle 130-4 may include an onboard computer, an onboard television, etc. In some embodiments, the requester terminal 130 may be a device with positioning technology for locating the position of the passenger and/or the requester terminal 130.

The provider terminal 140 may include a plurality of provider terminals 140-1, 140-2, . . . , 140-n. In some embodiments, the provider terminal 140 may be similar to, or the same device as the requester terminal 130. In some embodiments, the provider terminal 140 may be customized to be able to implement the O2O service system 100. In some embodiments, the provider terminal 140 may be a device with positioning technology for locating the service provider, the provider terminal 140, and/or a vehicle 150 associated with the provider terminal 140. In some embodiments, the requester terminal 130 and/or the provider terminal 140 may communicate with another positioning device to determine the position of the passenger, the requester terminal 130, the service provider, and/or the provider terminal 140. In some embodiments, the requester terminal 130 and/or the provider terminal 140 may periodically transmit the positioning information to the server 110. In some embodiments, the provider terminal 140 may also periodically transmit the availability status to the server 110. The availability status may indicate whether a vehicle 150 associated with the provider terminal 140 is available to carry a passenger. For example, the requester terminal 130 and/or the provider terminal 140 may transmit the positioning information and the availability status to the server 110 every thirty minutes. As another example, the requester terminal 130 and/or the provider terminal 140 may transmit the positioning information and the availability status to the server 110 each time the user logs into the mobile application associated with the O2O transportation service 100.

In some embodiments, the provider terminal 140 may correspond to one or more vehicles 150. The vehicles 150 may carry the passenger and travel to the destination. The vehicles 150 may include a plurality of vehicles 150-1, 150-2, . . . , 150-n. One vehicle may correspond to one type of services (e.g., a taxi-hailing service, a chauffeur service, an express car service, a carpool service, a bus service, a driver hire service, or a shuttle service). In some embodiments, the vehicles may include a car, an aircraft, a space shuttle, an electric car, a hybrid vehicle, or the like, or any combination thereof.

The storage device 160 may store data and/or instructions. In some embodiments, the storage device 160 may store data obtained from the requester terminal 130 and/or the provider terminal 140. In some embodiments, the storage device 160 may store data and/or instructions that the server 110 may execute or use to perform exemplary methods described in the present disclosure. In some embodiments, the storage device 160 may include a mass storage, removable storage, a volatile read-and-write memory, a read-only memory (ROM), or the like, or any combination thereof. Exemplary mass storage may include a magnetic disk, an optical disk, solid-state drives, etc. Exemplary removable storage may include a flash drive, a floppy disk, an optical disk, a memory card, a zip disk, a magnetic tape, etc. Exemplary volatile read-and-write memory may include a random-access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the storage device 160 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 160 may be connected to the network 120 to communicate with one or more components of the O2O service system 100 (e.g., the server 110, the requester terminal 130, or the provider terminal 140). One or more components of the O2O service system 100 may access the data or instructions stored in the storage device 160 via the network 120. In some embodiments, the storage device 160 may be directly connected to or communicate with one or more components of the O2O service system 100 (e.g., the server 110, the requester terminal 130, the provider terminal 140). In some embodiments, the storage device 160 may be part of the server 110.

The navigation device 170 may determine information associated with an object, for example, one or more of the requester terminal 130, the provider terminal 140, the vehicle 150, etc. In some embodiments, the navigation device 170 may be a global positioning system (GPS), a global navigation satellite system (GLONASS), a compass navigation system (COMPASS), a BeiDou navigation satellite system, a Galileo positioning system, a quasi-zenith satellite system (QZSS), etc. The information may include a location, an elevation, a velocity, or an acceleration of the object, or a current time. The navigation device 170 may include one or more satellites, for example, a satellite 170-1, a satellite 170-2, and a satellite 170-3. The satellites 170-1 through 170-3 may determine the information mentioned above independently or jointly. The satellite navigation device 170 may transmit the information mentioned above to the network 120, the requester terminal 130, the provider terminal 140, or the vehicle 150 via wireless connections.

In some embodiments, one or more components of the O2O service system 100 (e.g., the server 110, the requester terminal 130, the provider terminal 140) may have permissions to access the storage device 160. In some embodiments, one or more components of the O2O service system 100 may read and/or modify information related to the passenger, service provider, and/or the public when one or more conditions are met. For example, the server 110 may read and/or modify one or more passengers' information after a service is completed. As another example, the server 110 may read and/or modify one or more service providers' information after a service is completed.

One of ordinary skill in the art would understand that when an element (or component) of the O2O service system 100 performs, the element may perform through electrical signals and/or electromagnetic signals. For example, when a requester terminal 130 transmits out a service request to the server 110, a processor of the requester terminal 130 may generate an electrical signal encoding the request. The processor of the requester terminal 130 may then transmit the electrical signal to an output port. If the requester terminal 130 communicates with the server 110 via a wired network, the output port may be physically connected to a cable, which further may transmit the electrical signal to an input port of the server 110. If the requester terminal 130 communicates with the server 110 via a wireless network, the output port of the requester terminal 130 may be one or more antennas, which convert the electrical signal to electromagnetic signal. Similarly, a provider terminal 130 may receive an instruction and/or service request from the server 110 via electrical signal or electromagnet signals. Within an electronic device, such as the requester terminal 130, the provider terminal 140, and/or the server 110, when a processor thereof processes an instruction, transmits out an instruction, and/or performs an action, the instruction and/or action is conducted via electrical signals. For example, when the processor retrieves or saves data from a storage medium, it may transmit out electrical signals to a read/write device of the storage medium, which may read or write structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

FIG. 2 illustrates a schematic diagram of an exemplary computing device according to some embodiments of the present disclosure. The computing device may be a computer, such as the server 110 in FIG. 1 and/or a computer with specific functions, configured to implement any particular system according to some embodiments of the present disclosure. Computing device 200 may be configured to implement any components that perform one or more functions disclosed in the present disclosure. For example, the server 110 may be implemented in hardware devices, software programs, firmware, or any combination thereof of a computer like computing device 200. For brevity, FIG. 2 depicts only one computing device. In some embodiments, the functions of the computing device, providing function that recommending pick-up locations may require, may be implemented by a group of similar platforms in a distributed mode to disperse the processing load of the system.

Computing device 200 may include a communication terminal 250 that may connect with a network that may implement the data communication. Computing device 200 may also include a processor 220 that is configured to execute instructions and includes one or more processors. The schematic computer platform may include an internal communication bus 210, different types of program storage units and data storage units (e.g., a hard disk 270, a read-only memory (ROM) 230, a random-access memory (RAM) 240), various data files applicable to computer processing and/or communication, and some program instructions executed possibly by the processor 220. Computing device 200 may also include an I/O device 260 that may support the input and output of data flows between computing device 200 and other components. Moreover, computing device 200 may receive programs and data via the communication network.

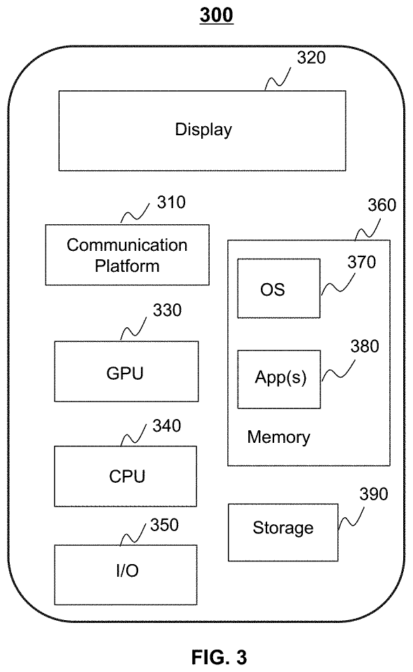

FIG. 3 is a schematic diagram illustrating exemplary hardware and/or software components of an exemplary mobile device on which a terminal may be implemented according to some embodiments of the present disclosure. As illustrated in FIG. 3, the mobile device 300 may include a communication platform 310, a display 320, a graphic processing unit (GPU) 330, a central processing unit (CPU) 340, an I/O 350, a memory 360, a mobile operating system (OS) 370, a storage 390. In some embodiments, any other suitable component, including but not limited to a system bus or a controller (not shown), may also be included in the mobile device 300.

In some embodiments, a mobile operating system 370 (e.g., iOS™, Android™, Windows Phone™, etc.) and one or more applications 380 may be loaded into the memory 360 from the storage 390 in order to be executed by the CPU 340. The applications 380 may include a browser or any other suitable mobile apps for receiving and rendering information relating to image processing or other information from the O2O service system 100. User interactions with the information stream may be achieved via the I/O 350 and provided to the database 130, the server 105 and/or other components of the O2O service system 100. In some embodiments, the mobile device 300 may be an exemplary embodiment corresponding to the requester terminal 130 or the provider terminal 140.

To implement various modules, units, and their functionalities described in the present disclosure, computer hardware platforms may be used as the hardware platform(s) for one or more of the elements described herein. A computer with user interface elements may be used to implement a personal computer (PC) or any other type of work station or terminal device. A computer may also act as a system if appropriately programmed.

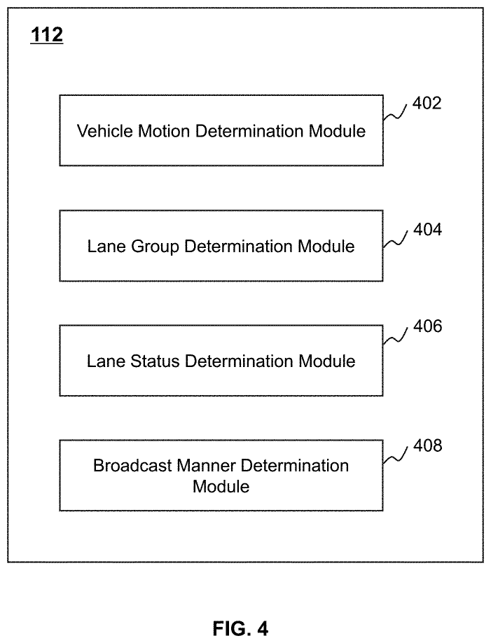

FIG. 4 is a schematic diagram illustrating an exemplary processing device according to some embodiments of the present disclosure. As shown in FIG. 4, the processing device 112 may include a vehicle motion determination module 402, a lane group determination module 404, a lane status determination module 406, and a broadcast manner determination module 408. In some embodiments, the modules may be hardware circuits of all or part of the processing device 112. The modules may also be implemented as an application or set of instructions read and executed by the processing device 112. Further, the modules may be any combination of the hardware circuits and the application/instructions. For example, the modules may be the part of the processing device 112 when the processing device 112 is executing the application/set of instructions.

The vehicle motion determination module 402 may be configured to determine a motion of a vehicle to be performed and/or being performed. In some embodiments, the vehicle motion determination module 402 may determine the motion of the vehicle to be performed when the vehicle is going to arrive at an intersection based on a planned driving route and a current location of the vehicle. In some embodiments, the motion of the vehicle may include going straight, making a left turn, making a right turn, and/or making a U-turn. In some embodiments, the vehicle motion determination module 402 may determine the current location of the vehicle and/or a lane on which the vehicle runs based on a GPS device (e.g., the requester terminal 130, the provider terminal 140, the navigation device 170) installed on the vehicle. In some embodiments, the vehicle motion determination module 402 may obtain the planned driving route from a storage device (e.g., the storage device 150, the ROM 230, the storage 390) or an external data source via the network 120. In some embodiments, the vehicle may include a private car, a taxi, an autonomous vehicle, an electric vehicle, a motorcycle, a bus, a train, a hitch, a bullet train, a high-speed railway, a subway, a vessel, an aircraft, a spaceship, a hot-air balloon, a driverless vehicle, or the like, or any combination thereof.

The lane group determination module 404 may be configured to determine one or more lane groups. For instance, the lane group determination module 404 may classify a plurality of lanes into one or more lane groups according to the lane marks on the plurality of lanes. The lane marks may include a going straight mark, a left turn mark, a right turn mark, a U-turn mark, a special lane mark, or the like, or any combination thereof. In some embodiments, the special lane mark may include a lane mark indicating a bus lane, a lane mark indicating a high-occupancy vehicle (HOV) lane, a lane mark indicating a tidal lane, or the like. Accordingly, the one or more lane groups may include a going straight lane group, a left turn lane group, a right turn lane group, a U-turn lane group, a special lane group, or the like, or any combination thereof. In some embodiments, the special lane group may include a bus lane group, a HOV lane group, a tidal lane group, or the like. Details regarding the determination of the lane group(s) may be found elsewhere in the present disclosure (e.g., operation 703 of process 700 and the descriptions thereof).

The lane status determination module 406 may be configured to determine a passable lane group and an impassable lane group based on the motion of the vehicle and the one or more lane groups. In some embodiments, the passable lane group may include one or more lanes that the vehicle can pass through. The impassable lane group may include one or more lanes that the vehicle cannot pass through. The lane status determination module 406 may also be configured to determine a lane status based on the passable lane group and the impassable lane group. The lane status may include a void lane status, an ordinary lane status, or the like. The void lane status may refer to a state that a single impassable lane of the impassable lane group is adjacent to only a passable lane of the passable lane group, or multiple adjacent impassable lanes of the impassable lane group are flanked by only a passable lane of the passable lane group. The ordinary lane status may refer to a state that a single impassable lane of the impassable lane group is adjacent to at least one impassable lane of the impassable lane group. Details regarding the determination of the lane status may be found elsewhere in the present disclosure (e.g., operation 705 of process 700, operations 803 and 805 of process 800, and the descriptions thereof).

In some embodiments, the lane status determination module 406 may also determine information related to the lane status based on the passable lane group and the impassable lane group. For example, the lane status determination module 406 may determine information related to the ordinary lane status. In some embodiments, the information related to the ordinary lane status may include a number of lanes in the passable lane group (i.e., a number of passable lanes), a number of lanes in the impassable lane group (i.e., a number of impassable lanes), a number of lanes on the left of the passable lane group, a number of lanes on the right of the passable lane group, or the like, or any combination thereof.

In some embodiments, when continuous intersections exist (e.g., a distance between a first intersection and a second intersection is less than a second threshold), the lane status determination module 406 may also be configured to determine a maximum number of lane change, an average lane change distance, a possible lane change distance, a minimum reserved going straight distance, or the like. The maximum number of lane change may refer to a maximum number of possible lane change between passable lane(s) in a passable lane group at the second intersection and a lane on which the vehicle runs. The passable lane group at the second intersection may be determined by the lane status determination module 406. The lane on which the vehicle runs may be determined according to a GPS device (e.g., the requester terminal 130, the provider terminal 140, the navigation device 170) installed on the vehicle. The average lane change distance may refer to an average drive distance required for lane change between any two adjacent lanes. The minimum reserved going straight distance may refer to a distance that prohibits lane change before passing the second intersection. The possible lane change distance may refer to a distance difference between a distance from the first intersection to the second intersection and the minimum reserved going straight distance. It should be noted that “distance” herein may be parallel to or substantially parallel to a direction of the lane.

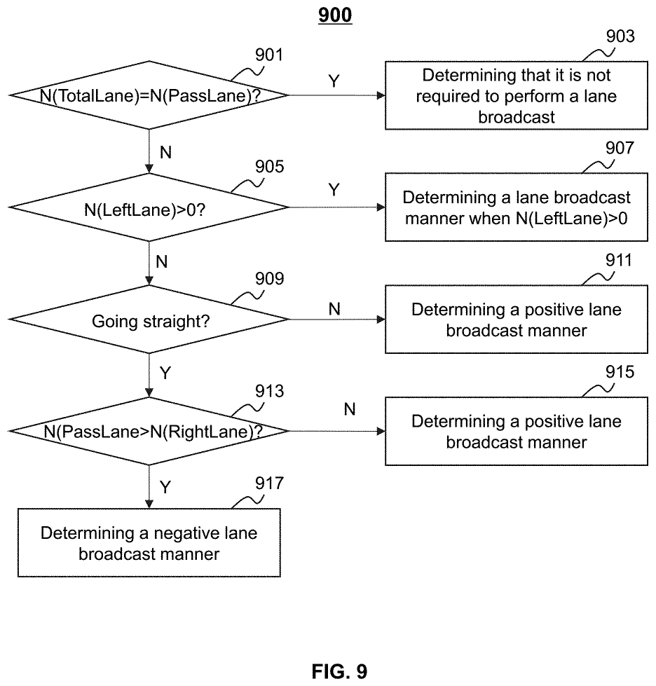

The broadcast manner determination module 408 may be configured to determine a lane broadcast manner based on the lane status and/or the information related to the lane status. In some embodiments, the lane broadcast manner may include a positive lane broadcast manner, a negative lane broadcast manner, or a combination of a positive lane broadcast manner and a negative lane broadcast manner. In some embodiments, the positive lane broadcast manner may be to broadcast passable lane(s) for a driver/user, e.g., “please drive on the left XX lanes.” The negative lane broadcast manner may be to broadcast impassable lane(s) for the driver/user, e.g., “please don't drive on the left XX lanes.” The combination of a positive lane broadcast manner and a negative lane broadcast manner may be to broadcast passable lane(s) and impassable lane(s) simultaneously for the driver/user, e.g., “please drive on the middle lane(s) and don't take the left XX lanes.” Details regarding the determination of the lane broadcast manner may be found elsewhere in the present disclosure (e.g., operation 707 of process 700, FIGS. 9, 10, 13, 14A and 14B, and the descriptions thereof).

The broadcast manner determination module 408 may also be configured to determine whether a distance for lane change from the first intersection to the second intersection is sufficient. In response to a determination that the distance for lane change is insufficient, the broadcast manner determination module 408 may determine a continuous lane broadcast manner. Details regarding the determination of the continuous lane broadcast manner may be found elsewhere in the present disclosure (e.g., FIGS. 11 and 12 and the descriptions thereof).

It should be noted that the above description of the processing device 112 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, any one of the modules may be divided into two or more units. For example, the lane status determination module 406 may be divided into two units. The first unit may be configured to determine the passable lane group and the impassable lane group. The second unit may be configured to determine the lane status and the information related to the lane status. In some embodiments, the processing device 112 may include one or more additional modules. For example, the processing device 112 may include a storage module (not shown). The storage module may be configured to store data generated during any process performed by any component of the processing device 112.

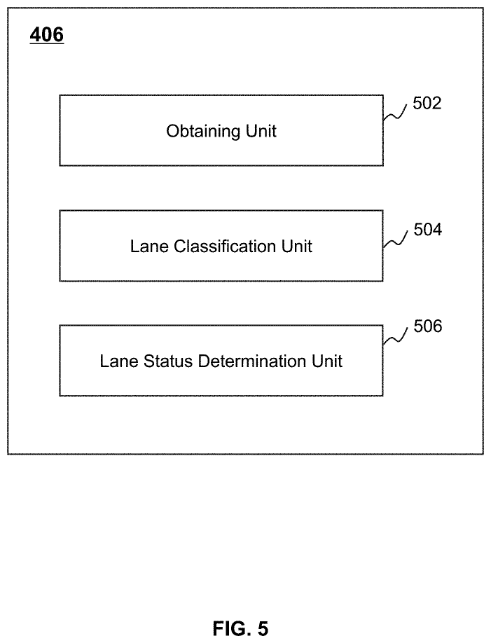

FIG. 5 is a schematic diagram illustrating an exemplary lane status determination module according to some embodiments of the present disclosure. As shown in FIG. 5, the lane status determination module 406 may include an obtaining unit 502, a lane classification unit 504, and a lane status determination unit 506. In some embodiments, the units of the lane status determination module 406 may be hardware circuits of all or part of the processing device 112. The units of the lane status determination module 406 may also be implemented as an application or set of instructions read and executed by the processing device 112. Further, the units may be any combination of the hardware circuits and the application/instructions. For example, the units may be the part of the processing device 112 when the processing device 112 is executing the application/set of instructions.

The obtaining unit 502 may be configured to obtain information and/or data related to the O2O service system 100. In some embodiments, the obtaining unit 502 may obtain the motion of the vehicle from the vehicle motion determination module 402, the storage device (e.g., the storage device 150, the ROM 230, the storage 390) via the network 120. The motion of the vehicle may include going straight, making a left turn, making a right turn, making a U-turn, or the like. In some embodiments, the obtaining unit 502 may obtain the one or more lane groups from the lane group determination module 404, the storage device (e.g., the storage device 150, the ROM 230, the storage 390) via the network 120. In some embodiments, the lane group(s) may include a going straight lane group, a left turn lane group, a right turn lane group, a U-turn lane group, a special lane group, or the like, or any combination thereof. The special lane group may include a bus lane group, a HOV lane group, a tidal lane group, or the like, or any combination thereof.

The lane classification unit 504 may be configured to determine a passable lane group and an impassable lane group. In some embodiments, the lane classification unit 504 may determine the passable lane group and the impassable lane group based on the motion of the vehicle and the lane group(s). Details regarding the determination of the passable lane group and the impassable lane group may be found elsewhere in the present disclosure (e.g., operation 803 of process 800 and the descriptions thereof).

The lane status determination unit 506 may be configured to determine a lane status based on the passable lane group and the impassable lane group. In some embodiments, the lane status may include a void lane status, an ordinary lane status. In some embodiments, the lane status determination unit 506 may be further configured to determine information related to the lane status (e.g., information related to the ordinary lane status). In some embodiments, the information related to the ordinary lane status may include a number of lanes in the passable lane group, a number of lanes in the impassable lane group, a number of lanes on the left of the passable lane group, and a number of lanes on the right of the passable lane group. The total number of lanes may be a sum of the number of lanes in the passable lane group and the number of lanes in the impassable lane group (i.e., a sum of the number of lanes on the left of the passable lane group and the number of lanes on the right of the passable lane group).

In some embodiments, the lane status determination unit 506 may also be configured to determine a maximum number of lane change, an average lane change distance, a possible lane change distance, a minimum reserved going straight distance, or the like.

It should be noted that the above description of the lane status determination module 406 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, the lane status determination unit 506 may be divided into two sub-units. The first sub-units may be configured to determine the lane status. The second sub-units may be configured to determine information related to the lane status.

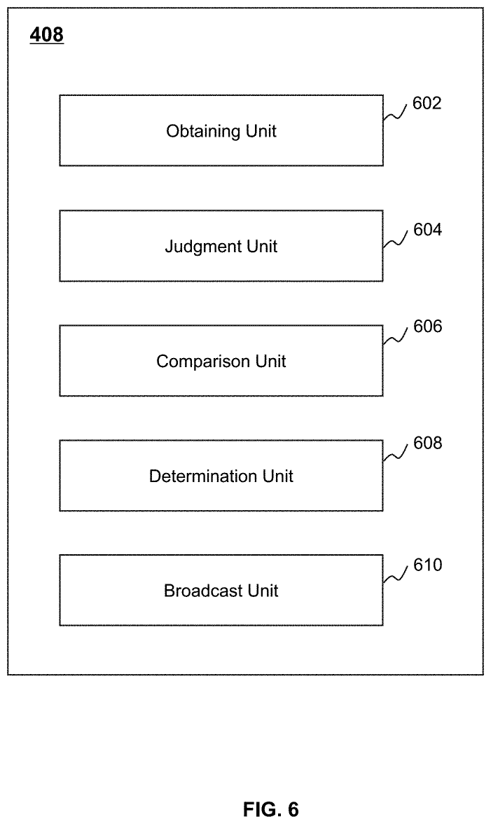

FIG. 6 is a schematic diagram illustrating an exemplary broadcast manner determination module according to some embodiments of the present disclosure. As shown in FIG. 6, the broadcast manner determination module 408 may include an obtaining unit 602, a judgment unit 604, a comparison unit 606, a determination unit 608, and a broadcast unit 608. In some embodiments, the units of the broadcast manner determination module 408 may be hardware circuits of all or part of the processing device 112. The units of the broadcast manner determination module 408 may also be implemented as an application or set of instructions read and executed by the processing device 112. Further, the units may be any combination of the hardware circuits and the application/instructions. For example, the units may be the part of the processing device 112 when the processing device 112 is executing the application/set of instructions.

The obtaining unit 602 may be configured to obtain information and/or data related to the O2O service system 100. In some embodiments, the obtaining unit 602 may obtain the lane status and the information related to the lane status. Alternatively, the obtaining unit 602 may obtain the maximum number of lane change, the average lane change distance, the possible lane change distance, the minimum reserved going straight distance, or the like. In some embodiments, the obtaining unit 602 may obtain the above information and/or data from the lane status determination module 406 or the storage device (e.g., the storage device 150, the ROM 230, the storage 390) via the network 120.

The judgment unit 604 may be configured to determine whether the total number of lanes is equal to the number of lanes in the passable lane group.

The comparison unit 606 may be configured to determine whether the number of lanes on the left of the passable lane group is greater than 0, and/or determine whether the number of lanes on the right of the passable lane group is greater than 0. The comparison unit 606 may also be configured to determine whether the number of lanes in the passable lane group is greater than the number of lanes on the right of the passable lane group, and/or determine whether the number of lanes in the passable lane group is greater than the number of lanes on the left of the passable lane group. The comparison unit 606 may be further configured to determine whether the number of lanes on the left of the passable lane group is equal to the number of lanes on the right of the passable lane group. The comparison unit 606 may be further configured to determine whether the number of lanes on the left of the passable lane group is equal to 1 and the number of lanes in the passable lane group is equal to 1; or determine whether the number of lanes on the right of the passable lane group is equal to 1 and the number of lanes in the passable lane group is equal to 1. In some embodiments, the comparison 606 may also be configured to determine whether a product of the maximum number of lane change multiplied by the average lane change distance is greater than the possible lane change distance.

The determination unit 608 may be configured to determine a lane broadcast manner according to judgment result(s) generated by the judgment unit 604, comparison result(s) generated by the comparison unit 606, and/or the lane status. In some embodiments, the lane broadcast manner may include a positive lane broadcast manner, a negative lane broadcast manner, a combination of a positive lane broadcast manner and a negative lane broadcast manner, or the like. In some embodiments, the determination unit 608 may determine a continuous lane broadcast manner based on the determination that the product of the maximum number of lane change multiplied by the average lane change distance is greater than the possible lane change distance.

The broadcast unit 610 may be configured to perform a lane broadcast according to the determined (continuous) lane broadcast manner. In some embodiments, the lane broadcast may include lane display, voice broadcast, video guide, a combination of the voice broadcast and the video guide, or the like.

It should be noted that the above description of the broadcast manner determination module 408 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, the broadcast manner determination module 408 may include a storage unit (not shown). The storage unit may be configured to store data generated during any process performed by any unit of the broadcast manner determination module 408.

FIG. 7 is a flowchart illustrating an exemplary process for determining a lane broadcast manner according to some embodiments of the present disclosure. For illustration purposes only, the processing device 112 may be described as a subject to perform the process 700. However, one of ordinary skill in the art would understand that the process 700 may also be performed by other entities. For example, one of ordinary skill in the art would understand that at least a portion of the process 700 may be implemented on the computing device 200 as illustrated in FIG. 2 or the mobile device 300 as illustrated in FIG. 3. In some embodiments, one or more operations of process 700 may be implemented on the O2O service system 100 as illustrated in FIG. 1. In some embodiments, one or more operations in the process 700 may be stored in the storage device 150 and/or the storage (e.g., the ROM 230, the RAM 240, etc.) as a form of instructions, and invoked and/or executed by the server 110 (e.g., the processing device 112 in the server 110, or the processor 220 of the processing device 112 in the server 110). In some embodiments, the instructions may be transmitted in a form of electronic current or electrical signals.

In 701, the processing device 112 (e.g., the vehicle motion determination module 402) may determine a motion of a vehicle. The motion of the vehicle may include going straight, making a left turn, making a right turn, making a U-turn, or the like. In some embodiments, the processing device 112 may determine a motion of the vehicle to be performed when the vehicle is going to arrive at an intersection based on a planned driving route and a current location of the vehicle. For example, if a vehicle will turn left at a next intersection according to the planned driving route, the processing device 112 may determine the motion of the vehicle at the next intersection as making a left turn. In some embodiments, the processing device 112 may determine a lane on which the vehicle runs and the current location of the vehicle according to a GPS device (e.g., the requester terminal 130, the provider terminal 140, the navigation device 170) installed on the vehicle. In some embodiments, the planned driving route may be determined based on a departure location and a destination. The planned driving route may be stored in a storage device (e.g., the storage device 150, the ROM 230, the storage 390) of the O2O service system 100 or an external data source (e.g., a Google map, a Baidu map, an Amap). The processing device 112 may obtain the planned driving route from the storage device (e.g., the storage device 150, the ROM 230, the storage 390) or the external data source via the network 120.

In 703, the processing device 112 (e.g., the lane group determination module 404) may determine one or more lane groups. The processing device 112 may classify a plurality of lanes into one or more lane groups according to lane marks on the plurality of lanes. For example, for one or more lanes having left turn marks, the processing device 112 may classify the one or more lanes into a left turn lane group. The number of the plurality of lanes may be any value, such as 2, 3, 4, 6, 8, 11, etc. In some embodiments, the lane mark(s) may include a going straight mark, a left turn mark, a right turn mark, a U-turn mark, a special lane mark, or the like, or any combination thereof. The special lane mark may include a lane mark indicating a bus lane, a lane mark indicating a high-occupancy vehicle (HOV) lane, a lane mark indicating a tidal lane, or the like, or any combination thereof. Corresponding to the lane mark(s), the lane group(s) may include a going straight lane group, a left turn lane group, a right turn lane group, a U-turn lane group, a special lane group, or the like, or any combination thereof. The special lane group may include a bus lane group, a HOV lane group, a tidal lane group, or the like, or any combination thereof. In some embodiments, the processing device 112 may obtain the lane marks from a storage device (e.g., the storage device 150, the ROM 230, the storage 390) of the O2O service system 100 or from an external data source via the network 120. Alternatively or additionally, the processing device 112 may obtain the lane marks through a vehicle-mounted camera, a car recorder, a vehicle-mounted sensor, a GPS device, or the like, or any combination thereof.

Each lane in a lane group may have the same lane mark. According to different lane marks, the processing device 112 may determine different lane groups. For example, if the lane marks on a plurality of lanes include going straight mark(s), left turn mark(s), and right turn mark(s), the processing device 112 may determine three lane groups, i.e., a going straight lane group, a left turn lane group, and a right turn lane group. Specifically, for a road with four lanes, if the lane marks on the four lanes include two going straight marks, one left turn mark, and one right turn mark, the processing device 112 may determine three lane groups, i.e., a going straight lane group (including two going straight lanes), a left turn lane group (including one left turn lane), and a right turn lane group (including one right turn lane). As another example, if the lane marks on a plurality of lanes include going straight mark(s), left turn mark(s), right turn mark(s), and U-turn mark(s), the processing device 112 may determine four lane groups, i.e., a going straight lane group, a left turn lane group, a right turn lane group, and a U-turn lane group. Specifically, for a road with seven lanes, if the lane marks on the seven lanes include two going straight marks, two left turn marks, two right turn marks, and one U-turn mark, the processing device 112 may determine four lane groups, i.e., a going straight lane group (including two going straight lanes), a left turn lane group (including two left turn lanes), a right turn lane group (including two right turn lanes), and a U-turn lane group (including one U-turn lane). As a further example, if the lane marks on a plurality of lanes include going straight mark(s), left turn mark(s), right turn mark(s), U-turn mark(s), and special lane mark(s), the processing device 112 may determine five lane groups, i.e., a going straight lane group, a left turn lane group, a right turn lane group, a U-turn lane group, and a special lane group. Specifically, for a road with seven lanes, if the lane marks on the seven lanes include two going straight marks, one left turn mark, one right turn mark, one U-turn mark, and two special lane marks, the processing device 112 may determine five lane groups, i.e., a going straight lane group (including two going straight lanes), a left turn lane group (including one left turn lane), a right turn lane group (including one right turn lane), a U-turn lane group (including one right turn lane), and a special lane group (including two special lanes).

In general, a lane may only belong to one lane group. In some embodiments, a lane may include more than one lane mark, e.g., including a left turn mark and a going straight mark. In this case, the processing device 112 may classify the lane into a left turn lane group or a going straight lane group based on the motion of the vehicle. For example, if the motion of the vehicle at the intersection is going straight, the processing device 112 may classify the lane into the going straight lane group. Alternatively, if the motion of the vehicle at the intersection is making a left turn, the processing device 112 may classify the lane into the left turn lane group.

In 705, the processing device 112 (e.g., the lane status determination module 406) may determine a lane status based on the motion of the vehicle and the one or more lane groups. In some embodiments, the processing device 112 may determine a passable lane group and an impassable lane group based on the one or more lane groups and the motion of the vehicle passable. In some embodiments, the passable lane group may include one or more lanes that the vehicle can pass through, while the impassable lane group may include one or more lanes that the vehicle cannot pass through. In some embodiments, for illustration purposes only, the lane(s) in the passable lane group may be labeled with “1”, and the lane(s) in the impassable lane group may be labeled with “0”.

The processing device 112 may determine the lane status based on the determined passable lane group and impassable lane group. In some embodiments, the lane status may include a void lane status, an ordinary lane status, or the like. The void lane status may refer to a state that a single impassable lane of the impassable lane group is adjacent to only a passable lane of the passable lane group. For example, the void lane status may be denoted as “1-0-1,” “0-1-0-1,” “0-1-0-1-0.” Alternatively, the void lane status may refer to a state that multiple adjacent impassable lanes of the impassable lane group are flanked by only a passable lane of the passable lane group. For example, the void lane status may be denoted as “1-0-0-1,” “0-1-1-0-0-1,” “0-1-0-00-1-1-0-0,” or the like. The ordinary lane status may refer to a state that a single impassable lane of the impassable lane group is adjacent to at least one impassable lane of the impassable lane group. For example, the ordinary lane status may be denoted as “0-1-0,” “0-1-1,” “0-0-1-1-1-0,” or the like. In some embodiments, the void lane status may be regarded as two or more ordinary lane statuses. For example, a void lane status “0-1-1-0-0-1-0” may be regarded as two ordinary lane statuses (e.g., an ordinary lane status “0-1-1-0” and an ordinary lane status “0-1-0”, or an ordinary lane status “0-1-1” and an ordinary lane status “0-0-1-0”, or the like). Details regarding the determination of the lane status may be found elsewhere in the present disclosure (e.g., operations 803 and 805 of process 800 and the relevant descriptions thereof).

In some embodiments, the processing device 112 (e.g., the lane status determination module 406) may also determine information related to the lane status based on the passable lane group and the impassable lane group. For example, the processing device 112 may determine information related to the ordinary lane status. In some embodiments, the information related to the ordinary lane status may include a number of lanes in the passable lane group (i.e., a number of passable lanes), a number of lanes in the impassable lane group (i.e., a number of impassable lanes), a number of lanes on the left of the passable lane group, and a number of lanes on the right of the passable lane group. A total number of lanes may be a sum of the number of lanes in the passable lane group and the number of lanes in the impassable lane group(s) (i.e., a sum of the number of lanes on the left of the passable lane group and the number of lanes on the right of the passable lane group). For example, for an ordinary lane status “0-0-1-1-1-0-0-0”, the number of lanes in the passable lane group may be three. The number of lanes on the left of the passable lane group may be two. The number of lanes on the right of the passable lane group may be three. Thus, the total number of lanes may be eight.

In 707, the processing device 112 (e.g., the broadcast manner determination module 408) may determine a lane broadcast manner based on the motion of the vehicle and the lane status. In some embodiments, the processing device 112 may determine the lane broadcast manner based on the motion of the vehicle, the lane status, and the information related to the lane status. In some embodiments, the lane broadcast manner may include a positive lane broadcast manner, a negative lane broadcast manner, or a combination of a positive lane broadcast manner and a negative lane broadcast manner. The positive lane broadcast manner may be to broadcast passable lane(s) for a driver/user, e.g., “please drive on the left XX lanes.” The negative lane broadcast manner may be to broadcast impassable lane(s) for the driver/user, e.g., “please don't drive on the left XX lanes.” The combination of a positive lane broadcast manner and a negative lane broadcast manner may be to broadcast passable lane(s) and impassable lane(s) simultaneously for the driver/user, e.g., “please drive on the middle lane(s) and don't drive on the left XX lanes.”

In some embodiments, if the lane status is a void lane status, the lane broadcast manner may be a negative lane broadcast manner. For example, for a void lane status “1-0-1”, the processing device 112 may determine a negative lane broadcast manner, i.e., “please don't drive on the middle lane.” Alternatively, as described in connection with operation 705, a void lane status may be regarded as two or more ordinary lane statuses. The lane broadcast manner of the void lane status may be determined based on a lane broadcast manner of each of the two or more ordinary lane statuses. For example, a void lane status “0-1-1-0-0-1-0” may be regarded as two ordinary lane statuses (e.g., a first ordinary lane status “0-1-1-0” and a second ordinary lane status “0-1-0”). If the motion of the vehicle is making a left turn, making a U-turn, the processing device 112 may determine a broadcast manner according to the first ordinary lane status “0-1-1-0”. If the motion of the vehicle is making a right turn, the processing device 112 may determine a broadcast manner according to the second ordinary lane status “0-1-0”. If the motion of the vehicle is going straight, the processing device 112 may determine a broadcast manner according to one of the first ordinary lane status “0-1-1-0” and the second ordinary lane status “0-1-0”. In some embodiments, for an ordinary lane status, the processing device 112 may determine the lane broadcast manner based on the number of lanes in the passable lane group, the number of lanes on the left of the passable lane group, and the number of lanes on the right of the passable lane group. Details regarding the determination of the lane broadcast manner of the ordinary lane status may be found elsewhere in the present disclosure (e.g., FIGS. 9,10, 13, 14A and 14B and the descriptions thereof).

It should be noted that the above description regarding the process 700 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, the processing device 112 may monitor a distance between the current location of the vehicle and the intersection. When the distance between the current location of the vehicle and the intersection is less than a first threshold, the processing device 112 may perform a lane broadcast according to the determined lane broadcast manner. In some embodiments, the first threshold may be a default value or an empirical value related to the O2O service system 100. For example, the first threshold may be set according to a default setting of the O2O service system 100, or preset or adjusted by a driver/user. In some embodiments, the lane broadcast may include lane display, voice broadcast, video guide, a combination of the voice broadcast and the video guide, or the like.

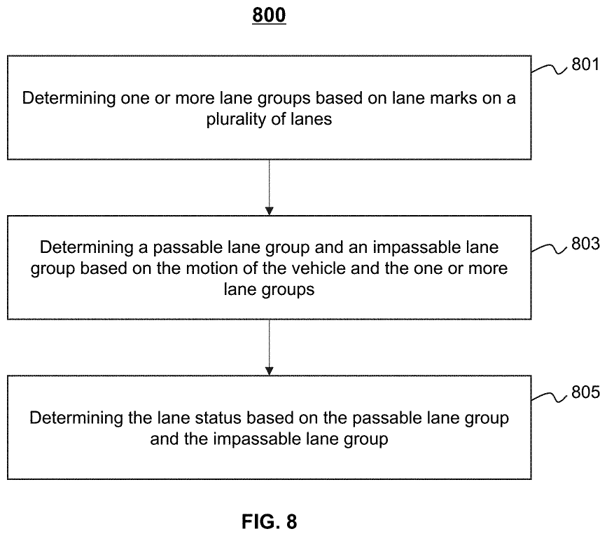

FIG. 8 is a flowchart illustrating an exemplary process for determining a lane status according to some embodiments of the present disclosure. For illustration purposes only, the processing device 112 may be described as a subject to perform the process 800. However, one of ordinary skill in the art would understand that the process 800 may also be performed by other entities. For example, one of ordinary skill in the art would understand that at least a portion of the process 800 may be implemented on the computing device 200 as illustrated in FIG. 2 or the mobile device 300 as illustrated in FIG. 3. In some embodiments, one or more operations of process 800 may be implemented on the O2O service system 100 as illustrated in FIG. 1. In some embodiments, one or more operations in the process 800 may be stored in the storage device 150 and/or the storage (e.g., the ROM 230, the RAM 240, etc.) as a form of instructions, and invoked and/or executed by the server 110 (e.g., the processing device 112 in the server 110, or the processor 220 of the processing device 112 in the server 110). In some embodiments, the instructions may be transmitted in a form of electronic current or electrical signals.

In 801, the processing device 112 (e.g., the lane group determination module 404) may determine the one or more lane groups based on lane marks on a plurality of lanes. In some embodiments, a road may include a plurality of lanes with its corresponding lane marks. The processing device 112 may classify the plurality of lanes into one or more lane groups according to the lane marks on the plurality of lanes. Each lane in a lane group may have the same lane mark. According to different lane marks, the processing device 112 may determine different lane groups. In some embodiments, the lane group(s) may include a going straight lane group, a left turn lane group, a right turn lane group, a U-turn lane group, a special lane group, or the like, or any combination thereof. More descriptions of the determination of the lane group(s) may be found elsewhere in the present disclosure (e.g., operation 703 of process 700 and the relevant descriptions thereof).

In 803, the processing device 112 (e.g., the lane classification unit 504 of the lane status determination module 406) may determine a passable lane group and an impassable lane group based on the motion of the vehicle and the one or more lane groups. In some embodiments, the passable lane group may include one or more lanes that the vehicle can pass through, while the impassable lane group may include one or more lanes that the vehicle cannot pass through. Merely by way of example, for a road with three lanes (e.g., belonging to a going straight lane group, a left turn lane group, and a right turn lane group, respectively), if the motion of the vehicle at the intersection is making a right turn, the processing device 112 may determine the lanes belonging to the going straight lane group and the left turn lane group as impassable lanes, and determine the lane belonging to the right turn lane group as a passable lane. As another example, for a road with four lanes (e.g., belonging to a going straight lane group, a left turn lane group, a right turn lane group, and a U-turn lane group, respectively), if the motion of the vehicle at the intersection is making a left turn or making a right turn, the processing device 112 may determine the lanes belonging to the going straight lane group and the U-turn lane group as impassable lanes, and determine the lanes belonging to the left turn lane group and the right turn lane group as passable lanes. In some embodiments, for illustration purposes only, the passable lane(s) in the passable lane group may be labeled with “1”, and the impassable lane(s) in the impassable lane group may be labeled with “0”.

In 805, the processing device 112 (e.g., the lane status determination unit 506 of the lane status determination module 406) may determine the lane status based on the passable lane group and the impassable lane group. In some embodiments, the processing device 112 may determine the lane status based on the passable lane(s) in the passable lane group and the impassable lane(s) in the impassable lane group. In some embodiments, the lane status may include a void lane status, an ordinary lane status, or the like.

The void lane status may refer to a state that a single impassable lane of the impassable lane group is adjacent to only a passable lane of the passable lane group, or multiple adjacent impassable lanes of the impassable lane group are flanked by only a passable lane of the passable lane group. For example, for a road with three lanes, if the second lane of the three lanes is an impassable lane of the impassable lane group, and the first and third lanes are passable lanes of the passable lane group, a void lane status may be formed. The void lane status may be denoted as “1-0-1”. As another example, for a road with four lanes, if the first and third lanes are impassable lanes of the impassable lane group, and the second and fourth lanes are passable lanes of the passable lane group, a void lane status may be formed. The void lane status may be denoted as “0-1-0-1”. As a further example, for a road with seven lanes, if the second and fifth lanes are passable lanes of the passable lane group, and the remaining five are impassable lanes of the impassable lane group, a void lane status may be formed. The void lane status may be denoted as “0-1-0-0-1-0-0”. The ordinary lane status may refer to a state that a single impassable lane of the impassable lane group is adjacent to at least one impassable lane of the impassable lane group. For example, for a road with three lanes, if the first lane is a passable lane of the passable lane group, and the second and third lanes are impassable lanes of the impassable lane group, an ordinary lane status may be formed. The ordinary lane status may be denoted as “1-0-0”. As another example, for a road with four lanes, if the second and third lanes are passable lanes of the passable lane group, and the first and fourth lanes are impassable lanes of the impassable lane group, an ordinary lane status may be formed. The ordinary lane status may be denoted as “0-1-1-0”. As a further example, for a road with seven lanes, if the third, fourth, and fifth lanes are passable lanes of the passable lane group, and the remaining four are impassable lanes of the impassable lane group, an ordinary lane status may be formed. The ordinary lane status may be denoted as “0-0-1-1-1-0-0”. In some embodiments, a void lane status may be regarded as two or more ordinary lane status. For example, for a void lane status “0-1-0-0-1-0”, the void lane status may be regarded as two ordinary lane statuses (e.g., an ordinary lane status “0-1” and an ordinary lane status “0-0-1-0”, or two ordinary lane statuses “0-1-0”, or the like). It should be noted that the above exemplary lane statuses are merely for illustration purposes, and are not intended to limit the scope of the present disclosure. The void lane status or the ordinary lane status may have other examples, as long as they conform to the definition of the void lane status or the ordinary lane status.

In some embodiments, the processing device 112 (e.g., the lane status determination unit 506 of the lane status determination module 406) may determine information related to the lane status based on the passable lane group and the impassable lane group. In some embodiments, the processing device 112 may determine information related to the ordinary lane status. In some embodiments, the information related to the ordinary lane status may include a number of lanes in the passable lane group (i.e., a number of passable lanes), a number of lanes in the impassable lane group (i.e., a number of impassable lanes), a number of lanes on the left of the passable lane group, and a number of lanes on the right of the passable lane group. The total number of lanes may be a sum of the number of lanes in the passable lane group and the number of lanes in the impassable lane group (i.e., a sum of the number of lanes on the left of the passable lane group and the number of lanes on the right of the passable lane group).

In some embodiments, a void lane status may be divided into two or more ordinary lane statuses. Thus, the lane broadcast manner of the void lane status may be determined according to the lane broadcast manner of the two or more ordinary lane statuses. In some embodiments, the processing device 112 may determine a lane broadcast manner of an ordinary lane status by taking the motion of the vehicle into account. For example, for the motion of the vehicle being going straight, the processing device 112 may determine the lane broadcast manner prone to middle lane(s). For the motion of the vehicle being making a right turn, the processing device 112 may determine the lane broadcast manner prone to right lane(s). For the motion of the vehicle being making a left turn or making a U-turn, the processing device 112 may determine the lane broadcast manner prone to left lane(s).

FIG. 9 is a flowchart illustrating an exemplary process for determining a lane broadcast manner of an ordinary lane status according to some embodiments of the present disclosure. For illustration purposes only, the processing device 112 may be described as a subject to perform the process 900. However, one of ordinary skill in the art would understand that the process 900 may also be performed by other entities. For example, one of ordinary skill in the art would understand that at least a portion of the process 900 may be implemented on the computing device 200 as illustrated in FIG. 2 or the mobile device 300 as illustrated in FIG. 3. In some embodiments, one or more operations of process 900 may be implemented on the 020 service system 100 as illustrated in FIG. 1. In some embodiments, one or more operations in the process 900 may be stored in the storage device 150 and/or the storage (e.g., the ROM 230, the RAM 240, etc.) as a form of instructions, and invoked and/or executed by the server 110 (e.g., the processing device 112 in the server 110, or the processor 220 of the processing device 112 in the server 110). In some embodiments, the instructions may be transmitted in a form of electronic current or electrical signals.

In 901, the processing device 112 (e.g., the judgment unit 604 of the broadcast manner determination module 408) may determine whether the total number of lanes (denoted as N(TotalLane)) is equal to the number of lanes in the passable lane group (denoted as N(PassLane)). In response to a determination that the N(TotalLane) is equal to the N(PassLane), the processing device 112 may proceed to operation 903. Alternatively, in response to a determination that the N(TotalLane) is not equal to the N(PassLane), the processing device 112 may proceed to operation 905.

In 903, the processing device 112 (e.g., the determination unit 608 of the broadcast manner determination module 408) may determine that it is not required to perform a lane broadcast.

In 905, the processing device 112 (e.g., the comparison unit 606 of the broadcast manner determination module 408) may determine whether the number of lanes on the left of the passable lane group (denoted as N(LeftLane)) is greater than 0. In response to a determination that the N(LeftLane) is greater than 0, the processing device 112 may proceed to operation 907. Alternatively, in response to a determination that the N(LeftLane) is equal to 0, the processing device 112 may proceed to operation 909.

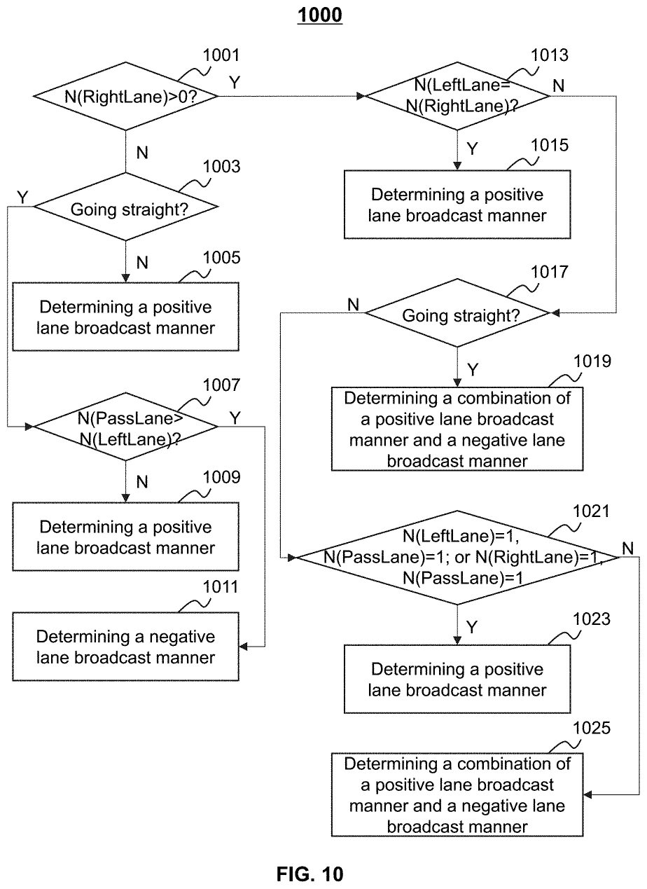

In 907, the processing device 112 (e.g., the determination unit 608 of the broadcast manner determination module 408) may determine a lane broadcast manner when the N(LeftLane) is greater than 0. Details regarding the determination of the lane broadcast manner when the N(LeftLane) is greater than 0 may be found elsewhere in the present disclosure (e.g., FIG. 10 and the descriptions thereof).

In 909, the processing device 112 (e.g., the vehicle motion determination module 402) may determine whether the motion of the vehicle is going straight. In response to a determination that the motion of the vehicle is not going straight, the processing device 112 may proceed to operation 911. Alternatively, in response to a determination that the motion of the vehicle is going straight, the processing device 112 may proceed to operation 913.

In 911, the processing device 112 (e.g., the determination unit 608 of the broadcast manner determination module 408) may determine a positive lane broadcast manner.

In 913, the processing device 112 (e.g., the comparison unit 606 of the broadcast manner determination module 408) may determine whether the N(PassLane) is greater than the number of lanes on the right of the passable lane group (denoted as N(RightLane)). In response to a determination that the N(PassLane) is not greater than the N(RightLane), the processing device 112 may proceed to operation 915. Alternatively, in response to a determination that the N(PassLane) is greater than the N(RightLane), the processing device 112 may proceed to operation 917.

In 915, the processing device 112 (e.g., the determination unit 608 of the broadcast manner determination module 408) may determine a positive lane broadcast manner.

In 917, the processing device 112 (e.g., the determination unit 608 of the broadcast manner determination module 408) may determine a negative lane broadcast manner.

FIG. 10 is a flowchart illustrating an exemplary process for determining a lane broadcast manner of the ordinary lane status in FIG. 9 when the N(LeftLane) is greater than 0 according to some embodiments of the present disclosure. For illustration purposes only, the processing device 112 may be described as a subject to perform the process 1000. However, one of ordinary skill in the art would understand that the process 1000 may also be performed by other entities. For example, one of ordinary skill in the art would understand that at least a portion of the process 1000 may be implemented on the computing device 200 as illustrated in FIG. 2 or the mobile device 300 as illustrated in FIG. 3. In some embodiments, one or more operations of process 1000 may be implemented on the O2O service system 100 as illustrated in FIG. 1. In some embodiments, one or more operations in the process 1000 may be stored in the storage device 150 and/or the storage (e.g., the ROM 230, the RAM 240, etc.) as a form of instructions, and invoked and/or executed by the server 110 (e.g., the processing device 112 in the server 110, or the processor 220 of the processing device 112 in the server 110). In some embodiments, the instructions may be transmitted in a form of electronic current or electrical signals.

In 1001, the processing device 112 (e.g., the comparison unit 606 of the broadcast manner determination module 408) may determine whether the N(RightLane) is greater than 0. In response to a determination that the N(RightLane) is equal to 0, the processing device 112 may proceed to operation 1003. Alternatively, in response to a determination that the N(RightLane) is greater than 0, the processing device 112 may proceed to operation 1013.

In 1003, the processing device 112 (e.g., the vehicle motion determination module 402) may determine whether the motion of the vehicle is going straight. In response to a determination that the motion of the vehicle is not going straight, the processing device 112 may proceed to operation 1005. Alternatively, in response to a determination that the motion of the vehicle is going straight, the processing device 112 may proceed to operation 1007.

In 1005, the processing device 112 (e.g., the determination unit 608 of the broadcast manner determination module 408) may determine a positive lane broadcast manner.

In 1007, the processing device 112 (e.g., the comparison unit 606 of the broadcast manner determination module 408) may determine whether the N(PassLane) is greater than the N(LeftLane). In response to a determination that the N(PassLane) is not greater than the N(LeftLane), the processing device 112 may proceed to operation 1009. Alternatively, in response to a determination that the N(PassLane) is greater than the N(LeftLane), the processing device 112 may proceed to operation 1011.

In 1009, the processing device 112 (e.g., the determination unit 608 of the broadcast manner determination module 408) may determine a positive lane broadcast manner.

In 1011, the processing device 112 (e.g., the determination unit 608 of the broadcast manner determination module 408) may determine a negative lane broadcast manner.

In 1013, the processing device 112 (e.g., the comparison unit 606 of the broadcast manner determination module 408) may determine whether the N(LeftLane) is equal to the N(RightLane). In response to a determination that the N(LeftLane) is equal to the N(RightLane), the processing device 112 may proceed to operation 1015. Alternatively, in response to a determination that the N(LeftLane) is not equal to the N(RightLane), the processing device 112 may proceed to operation 1017.

In 1015, the processing device 112 (e.g., the determination unit 608 of the broadcast manner determination module 408) may determine a positive lane broadcast manner.

In 1017, the processing device 112 (e.g., the vehicle motion determination module 402) may determine whether the motion of the vehicle is going straight. In response to a determination that the motion of the vehicle is going straight, the processing device 112 may proceed to operation 1019. Alternatively, in response to a determination that the motion of the vehicle is not going straight, the processing device 112 may proceed to operation 1021.

In 1019, the processing device 112 (e.g., the determination unit 608 of the broadcast manner determination module 408) may determine a combination of a positive lane broadcast manner and a negative lane broadcast manner.

In 1021, the processing device 112 (e.g., the comparison unit 606 of the broadcast manner determination module 408) may determine whether the N(LeftLane) is equal to 1 and the N(PassLane) is equal to 1, or the N(RightLane) is equal to 1 and the N(PassLane) is equal to 1. In response to a determination that the N(LeftLane) is equal to 1 and the N(PassLane) is equal to 1, or the N(RightLane) is equal to 1 and the N(PassLane) is equal to 1, the processing device 112 may proceed to operation 1023. Alternatively, if the N(LeftLane) is equal to 1 and the N(PassLane) is equal to 1 is not satisfied, and the N(RightLane) is equal to 1 and the N(PassLane) is equal to 1 is not satisfied, the processing device 112 may proceed to operation 1025.

In 1023, the processing device 112 (e.g., the determination unit 608 of the broadcast manner determination module 408) may determine a positive lane broadcast manner.

In 1025, the processing device 112 (e.g., the determination unit 608 of the broadcast manner determination module 408) may determine a combination of a positive lane broadcast manner and a negative lane broadcast manner. The combination of a positive lane broadcast manner and a negative lane broadcast manner may be to broadcast passable lane(s) and impassable lane(s) simultaneously for the driver/user, e.g., “please drive on the middle lane(s) and don't drive on the left XX lanes.”

In some embodiments, when continuous intersections exist (e.g., a distance between a first intersection and a second intersection is less than a second threshold), the driver may need to be prepared at the first intersection so that a distance for lane change at the second intersection is sufficient. For example, the processing device 112 may direct the driver to drive to a suitable lane at the first intersection so that the driver can drive to a lane corresponding to the motion of the vehicle at the second intersection after passing the first intersection. In some embodiments, after determining a lane broadcast manner at an intersection according to process 700, the processing device 112 may determine whether a distance between the intersection (also referred to as first intersection) and a next intersection (also referred to as second intersection) is less than a second threshold. In response to a determination that the distance between the first intersection and the second intersection is not less than the second threshold, the processing device 112 may determine that there are no continuous intersections, and will perform a lane broadcast according to the determined lane broadcast manner. Alternatively, in response to a determination that the distance between the first intersection and the second intersection is less than the second threshold, the processing device 112 may determine that continuous intersections exist, and may modify the determined broadcast manner, e.g., to determine a continuous lane broadcast manner. In some embodiments, the second threshold may be a default value or an empirical value related to the O2O service system 100. In some embodiments, the second threshold may be set according to a default setting of the O2O service system 100, or preset or adjusted by a user/driver.

FIG. 11 is a flowchart illustrating an exemplary process for determining a continuous lane broadcast manner according to some embodiments of the present disclosure. For illustration purposes only, the processing device 112 may be described as a subject to perform the process 1100. However, one of ordinary skill in the art would understand that the process 1100 may also be performed by other entities. For example, one of ordinary skill in the art would understand that at least a portion of the process 1100 may be implemented on the computing device 200 as illustrated in FIG. 2 or the mobile device 300 as illustrated in FIG. 3. In some embodiments, one or more operations of process 1300 may be implemented on the 020 service system 100 as illustrated in FIG. 1. In some embodiments, one or more operations in the process 1100 may be stored in the storage device 150 and/or the storage (e.g., the ROM 230, the RAM 240, etc.) as a form of instructions, and invoked and/or executed by the server 110 (e.g., the processing device 112 in the server 110, or the processor 220 of the processing device 112 in the server 110). In some embodiments, the instructions may be transmitted in a form of electronic current or electrical signals.

In 1101, the processing device 112 (e.g., the lane status determination module 406) may determine a maximum number of lane change, an average lane change distance, a possible lane change distance, and a minimum reserved going straight distance.

In some embodiments, the maximum number of lane change may be determined according to passable lane(s) in a passable lane group at the second intersection and a lane on which the vehicle runs. The passable lane group at the second intersection may be determined according to the motion of the vehicle at the second intersection. In some embodiments, the passable lane group at the second intersection may be determined according to operations 701 to 705 as illustrated in FIG. 7. The lane on which the vehicle runs may be determined according to a GPS device (e.g., the requester terminal 130, the provider terminal 140, the navigation device 170) installed on the vehicle. In some embodiments, the maximum number of lane change may refer to a maximum number of possible lane change between the passable lane(s) in the passable lane group at the second intersection and the lane on which the vehicle runs. The average lane change distance may refer to an average drive distance required for lane change between two adjacent lanes. The minimum reserved going straight distance may refer to a distance that prohibits lane change before passing the second intersection. The possible lane change distance may refer to a distance difference between a distance from the first intersection to the second intersection and the minimum reserved going straight distance. It should be noted that “distance” herein may be parallel to or substantially parallel to a direction of the lane. For illustration purposes, FIG. 12 illustrates exemplary continuous intersections including a first intersection and a second intersection. As shown in FIG. 12, dotted lines indicate lane lines used for distinguishing different lanes. The curve indicates the driving trajectory of the vehicle from the current location to the second intersection. At the first intersection, there are three lanes, i.e., L1, L2, and L3. At the second intersection, there are four lanes, i.e., L′1, L′2, L′3, and L′4. The maximum number of lane change may be three as shown in FIG. 12. A length 1206 may indicate the distance from the first intersection to the second intersection. A length 1208 may indicate the minimum reserved going straight distance. Thus, the possible lane change distance may be a difference between the length 1206 and the length 1208 (i.e., 1206-1208).

In 1103, the processing device 112 (e.g., the broadcast manner determination module 408) may determining whether a product of the maximum number of lane change multiplied by the average lane change distance is greater than the possible lane change distance. If yes, the processing device 112 may determine that a distance for lane change from the first intersection to the second intersection is insufficient. In this case, the processing device 112 may proceed to operation 1105.

In 1105, the processing device 112 (e.g., the broadcast manner determination module 408) may determine a continuous lane broadcast. For example, the processing device 112 may direct a driver to drive to a lane with a least number of lane change in advance. In some embodiments, the lane with the least number of lane change may refer to a lane in the passable lane group at the first intersection. For example, as shown in FIG. 12, lanes L′3 and L′4 may belong to the passable lane group at the second intersection. Lanes L1 and L2 may belong to the passable lane group at the first intersection. Lane L2 may be defined as the lane with the least number of lane change. The processing device 112 may direct the driver to drive to lane L2 at the first intersection. In some embodiments, the continuous lane broadcast manner may be “please drive on the right two lanes (i.e., lanes L1 and L2), please drive on the left lane (i.e., lane L2).” In some embodiments, the lane with the least number of lane change may refer to a lane in the passable lane group at the second intersection. For example, as shown in FIG. 12, lanes L′3 and L′4 may belong to the passable lane group at the second intersection. Lanes L1 and L2 may belong to the passable lane group at the first intersection. Lane L′3 may be defined as the lane with the least number of lane change. The processing device 112 may direct the driver to drive to lane L3 immediately after passing the first intersection. In some embodiments, the continuous lane broadcast manner may be “please drive on the right two lanes (i.e., lanes L1 and L2), please drive to the second lane on the left (i.e., lanes L′3) immediately after passing the first intersection.”

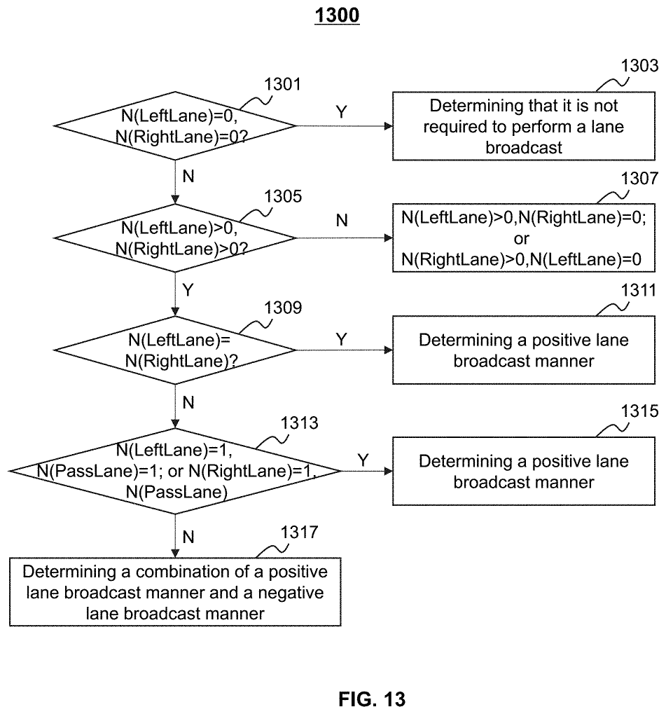

In some embodiments, the lane broadcast manner of an ordinary lane status may be determined according to one or more approaches other than the process illustrated in FIGS. 9 and 10. Merely by way of example, FIG. 13 illustrates an exemplary process for determining the lane broadcast manner of an ordinary lane status according to some embodiments of the present disclosure. For illustration purposes only, the processing device 112 may be described as a subject to perform the process 1300. However, one of ordinary skill in the art would understand that the process 1300 may also be performed by other entities. For example, one of ordinary skill in the art would understand that at least a portion of the process 1300 may be implemented on the computing device 200 as illustrated in FIG. 2 or the mobile device 300 as illustrated in FIG. 3. In some embodiments, one or more operations of process 1300 may be implemented on the O2O service system 100 as illustrated in FIG. 1. In some embodiments, one or more operations in the process 1300 may be stored in the storage device 150 and/or the storage (e.g., the ROM 230, the RAM 240, etc.) as a form of instructions, and invoked and/or executed by the server 110 (e.g., the processing device 112 in the server 110, or the processor 220 of the processing device 112 in the server 110). In some embodiments, the instructions may be transmitted in a form of electronic current or electrical signals.

In 1301, the processing device 112 (e.g., the broadcast manner determination module 408) may determine whether the N(LeftLane) is equal to 0 and the N(RightLane) is equal to 0 (i.e., all lanes belonging to the passable lane group). In response to a determination that the N(LeftLane) and the N(RightLane) are both equal to 0, the processing device 112 may determine that all lanes belong to the passable lane group, and may proceed to operation 1303. In 1303, the processing device 112 (e.g., the broadcast manner determination module 408) may determine that it is not required to perform a lane broadcast. The driver of the vehicle can drive on any one lane.

Alternatively, in response to a determination that the N(LeftLane) is not equal to 0 or the N(RightLane) is not equal to 0, the processing device 112 may proceed to operation 1305. In 1305, the processing device 112 (e.g., the broadcast manner determination module 408) may determine whether the N(LeftLane) is greater than 0 and the N(RightLane) is greater than 0. If the N(LeftLane) is greater than 0 and the N(RightLane) is greater than 0 is not satisfied, the processing device 112 may proceed to operation 1307. In 1307, the processing device 112 (e.g., the broadcast manner determination module 408) may determine that the N(LeftLane) is greater than 0 and the N(RightLane) is equal to 0, or the N(RightLane) is greater than 0 and the N(LeftLane) is equal to 0.

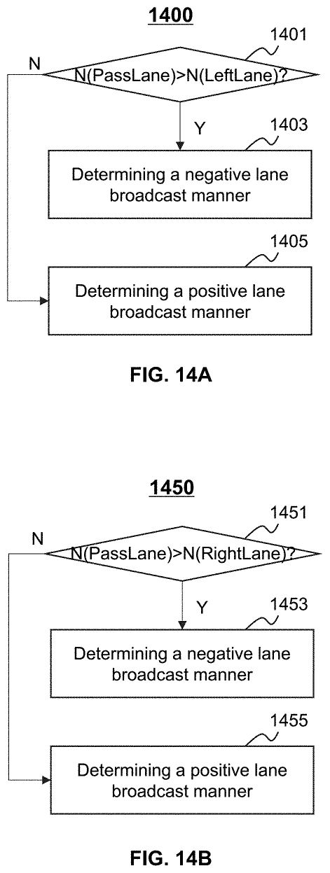

When the N(LeftLane) is greater than 0 and the N(RightLane) is equal to 0, a lane broadcast manner may be determined according to process 1400 described in connection with FIG. 14A. In 1401, the processing device 112 (e.g., the broadcast manner determination module 408) may determine whether the N(PassLane) is greater than the N(LeftLane). In response to a determination that the N(PassLane) is greater than the N(LeftLane), the processing device 112 may proceed to operation 1403. In 1403, the processing device 112 (e.g., the broadcast manner determination module 408) may determine a negative lane broadcast manner. For example, if the N(LeftLane) is equal to 1, the negative lane broadcast manner may be “please don't drive on the leftmost lane.” As another example, if the N(LeftLane) (represented by a symbol “N_{L}”) is greater than 1, the negative lane broadcast manner may be “please don't drive on the left N_{L} lanes.” Alternatively, in response to a determination that the N(PassLane) is less than the N(LeftLane), the processing device 112 may proceed to operation 1405. In 1405, the processing device 112 (e.g., the broadcast manner determination module 408) may determine a positive lane broadcast manner. For example, if the N(PassLane) is equal to 1, the positive lane broadcast manner may be “please drive on the rightmost lane.” As another example, if the N(PassLane) (represented by a symbol “N_{P}”) is greater than 1, the positive lane broadcast manner may be “please drive on the right N_{P} lanes.”

When the N(RightLane) is greater than 0 and the N(LeftLane) is equal to 0, a lane broadcast manner may be determined according to process 1450 described in connection with FIG. 14B. In 1451, the processing device 112 (e.g., the broadcast manner determination module 408) may determine whether the N(PassLane) is greater than the N(RightLane). In response to a determination that the N(PassLane) is greater than the N(RightLane), the processing device 112 may proceed to operation 1453. In 1453, the processing device 112 (e.g., the broadcast manner determination module 408) may determine a negative lane broadcast manner. For example, if the N(RightLane) is equal to 1, the negative lane broadcast manner may be “please don't drive on the rightmost lane.” As another example, if the N(RightLane) (represented by a symbol “N_{R}”) is greater than 1, the negative lane broadcast manner may be “please don't drive on the right N_{R} lanes.” Alternatively, in response to a determination that the N(PassLane) is less than the N(RightLane), the processing device 112 may proceed to operation 1405. In 1405, the processing device 112 (e.g., the broadcast manner determination module 408) may determine a positive lane broadcast manner. For example, if the N(PassLane) is equal to 1, the positive lane broadcast manner may be “please drive on the leftmost lane.” As another example, if the N(PassLane) (represented by a symbol “Np”) is greater than 1, the positive lane broadcast manner may be “please drive on the left N_{P} lanes.”

Alternatively, in response to a determination that the N(LeftLane) and the N(RightLane) are both greater than 0, the processing device 112 may proceed to operation 1309. In 1309, the processing device 112 (e.g., the broadcast manner determination module 408) may determine whether the N(LeftLane) is equal to the N(RightLane). In response to a determination that the N(LeftLane) is equal to the N(RightLane), the processing device 112 may proceed to operation 1311. In 1311, the processing device 112 (e.g., the broadcast manner determination module 408) may determine a positive lane broadcast manner. For example, if the N(PassLane) is equal to 1, the positive lane broadcast manner may be “please drive on the middle lane.” Alternatively, if the N(PassLane) (represented by a symbol “Np”) is greater than 1, the positive lane broadcast manner may be “please drive on the middle N_{P} lanes.”

Alternatively, in response to a determination that the N(LeftLane) is not equal to the N(RightLane), the processing device 112 may proceed to operation 1313. In 1313, the processing device 112 (e.g., the broadcast manner determination module 408) may determine whether the N(LeftLane) is equal to 1 and the N(PassLane) is equal to 1, or the N(RightLane) is equal to 1 and the N(PassLane) is equal to 1. In response to a determination that the N(LeftLane) is equal to 1 and the N(PassLane) is equal to 1, or the N(RightLane) is equal to 1 and the N(PassLane) is equal to 1, the processing device 112 may proceed to operation 1315. In 1315, the processing device 112 (e.g., the broadcast manner determination module 408) may determine a positive lane broadcast manner. For example, if the N(LeftLane) is equal to 1 and the N(PassLane) is equal to 1, the positive lane broadcast manner may be “please drive on the second lane on the left.” As another example, if the N(RightLane) is equal to 1 and the N(PassLane) is equal to 1, the positive lane broadcast manner may be “please drive on the second lane on the right.”

Alternatively, if the N(LeftLane) is equal to 1 and the N(PassLane) is equal to 1 is not satisfied, and the N(RightLane) is equal to 1 and the N(PassLane) is equal to 1 is not satisfied, the processing device 112 may proceed to operation 1317. In 1317, the processing device 112 (e.g., the broadcast manner determination module 408) may determine a combination of a positive lane broadcast manner and a negative lane broadcast manner. In some embodiments, for illustration purposes, the N(LeftLane) may be represented by a symbol “N_{L}”. The N(RightLane) may be represented by a symbol “N_{R}”. The N(PassLane) may be represented by a symbol “N_{P}”. In some embodiments, if the N(LeftLane) is greater than the N(RightLane), the combination of a positive lane broadcast manner and a negative lane broadcast manner may be “please drive on the middle N_{P} lanes and don't drive on the left N_{L} lanes.” Alternatively, if the N(LeftLane) is less than the N(RightLane), the combination of a positive lane broadcast manner and a negative lane broadcast manner may be “please drive on the middle N_{P} lanes and don't drive on the right N_{R} lanes.”

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment,” “one embodiment,” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “block,” “module,” “engine,” “unit,” “component,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 1703, Perl, COBOL 1702, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a software as a service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution—e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A lane-based broadcast method, implemented on a computing device having at least one processor, at least one storage medium, and a communication platform connected to a network, comprising:
determining a motion of a vehicle to be performed when the vehicle is going to arrive at an intersection based on a planned driving route and a current location of the vehicle;
determining one or more lane groups;
determining a lane status based on the motion of the vehicle and the one or more lane groups; and
determining a lane broadcast manner based on the motion of the vehicle and the lane status;
the lane status being a status of road composed of different lane groups of the one or more lane groups.

2. The lane-based broadcast method of claim 1, wherein the motion of the vehicle includes going straight, making a left turn, making a right turn, or making a U-turn.

3. The lane-based broadcast method of claim 1, wherein the determining one or more lane groups comprises:
classifying a plurality of lanes into the one or more lane groups according to lane marks on the plurality of lanes.

4. The lane-based broadcast method of claim 3, wherein the determining a lane status comprises:
determining a passable lane group and an impassable lane group based on the motion of the vehicle and the one or more lane groups; and
determining the lane status based on the passable lane group and the impassable lane group.

5. The lane-based broadcast method of claim 4, wherein each lane in each lane group of the one or more lane groups has a same lane mark.

6. The lane-based broadcast method of claim 4, wherein the lane marks include at least one of a going straight mark, a left turn mark, a right turn mark, a U-turn mark, or a special lane mark.

7. The lane-based broadcast method of claim 6, wherein the one or more lane groups include at least one of a going straight lane group, a left turn lane group, a right turn lane group, a U-turn lane group, or a special lane group.

8. The lane-based broadcast method of claim 4, wherein the lane status includes a void lane status and an ordinary lane status.

9. The lane-based broadcast method of claim 8, wherein the void lane status refers to a state that a single impassable lane of the impassable lane group is adjacent to only a passable lane of the passable lane group, or multiple adjacent impassable lanes of the impassable lane group are flanked by only a passable lane of the passable lane group.

10. The lane-based broadcast method of claim 8, wherein the ordinary lane status refers to a state that a single impassable lane of the impassable lane group is adjacent to at least one impassable lane of the impassable lane group.

11. The lane-based broadcast method of claim 8, wherein the lane broadcast manner includes a positive lane broadcast manner, a negative lane broadcast manner, or a combination of a positive lane broadcast manner and a negative lane broadcast manner.

12. The lane-based broadcast method of claim 11, wherein if the lane status is the void lane status, the lane broadcast manner is the negative lane broadcast manner.

13. The lane-based broadcast method of claim 11, wherein the void lane status is regarded as two or more of the ordinary lane status, and the lane broadcast manner of the void lane status is determined based on a lane broadcast manner of each of the two or more ordinary lane statuses.

14. The lane-based broadcast method of claim 11, wherein if the lane status is the ordinary lane status, the method comprises:
determining the lane broadcast manner based on a number of lanes in the passable lane group, a number of lanes on the left of the passable lane group, and a number of lanes on the right of the passable lane group.

15. The lane-based broadcast method of claim 14, wherein the determining the lane broadcast manner comprises:
determining whether a total number of lanes is equal to the number of lanes in the passable lane group;
in response to a determination that the total number of lanes is equal to the number of lanes in the passable group, determining that it is not required to perform the lane broadcast; and
in response to a determination that the total number of lanes is not equal to the number of lanes in the passable group, determining the lane broadcast manner based on the number of lanes in the passable lane group, the number of lanes on the left of the passable lane group, the number of lanes on the right of the passable lane group, and the motion of the vehicle.

16. The lane-based broadcast method of claim 1, further comprising:
performing a lane broadcast according to the determined lane broadcast manner when a distance between the current location of the vehicle and the intersection is less than a threshold.

17. The lane-based broadcast method of claim 1, further comprising:
determining a continuous lane broadcast manner when continuous intersections exist.

18. The lane-based broadcast method of claim 17, wherein the determining a continuous lane broadcast manner comprises:
determining a maximum number of lane change, an average lane change distance, a possible lane change distance, and a minimum reserved going straight distance;
determining whether a product of the maximum number of lane change multiplied by the average lane change distance is greater than the possible lane change distance; and
in response to a determination that the product of the maximum number of lane change multiplied by the average lane change distance is greater than the possible lane change distance, determining that a distance for lane change is insufficient, and directing a driver to drive to a lane with a least number of lane change in advance.

19. A lane-based broadcast system, comprising:
at least one storage device including a set of instructions;
at least one processor in communication with the at least one storage device, wherein when executing the set of instructions, the at least one processor is directed to:
determine a motion of a vehicle to be performed when the vehicle is going to arrive at an intersection based on a planned driving route and a current location of the vehicle;
determine one or more lane groups;
determine a lane status based on the motion of the vehicle and the one or more lane groups; and
determine a lane broadcast manner based on the motion of the vehicle and the lane status;
the lane status being a status of road composed of different lane groups of the one or more lane groups.

20-21. (canceled)

22. A lane-based broadcast apparatus, comprising a processor configured to run programs, wherein when running the programs, the processor performs a lane-based broadcast method, the lane-based broadcast method comprising:
determining a motion of a vehicle to be performed when the vehicle is going to arrive at an intersection based on a planned driving route and a current location of the vehicle;
determining one or more lane groups;
determining a lane status based on the motion of the vehicle and the one or more lane groups; and
determining a lane broadcast manner based on the motion of the vehicle and the lane status;
the lane status being a status of road composed of different lane groups of the one or more lane groups.

23-24. (canceled)
